(19) United States
(12) Patent Application Publication
(10) Pub. No.: US 2026/0012711 A1
(43) Pub. Date: Jan. 8, 2026

(54) IMAGING SYSTEM AND METHOD

(71) Applicant: Panasonic Intellectual Property Management Co., Ltd., Osaka (JP)

(72) Inventors: SATOSHI SATO, Kyoto (JP); TAKAYUKI KIYOHARA, Osaka (JP)

(21) Appl. No.: 19/329,640

(22) Filed: Sep. 16, 2025

Related U.S. Application Data
(63) Continuation of application No. PCT/JP2024/009554, filed on Mar. 12, 2024.

(30) Foreign Application Priority Data
Mar. 31, 2023 (JP) 2023-057197

(51) Int. Cl. H04N 23/95; H04N 23/56; H04N 23/667; H04N 23/68

(52) U.S. Cl. CPC H04N 23/95; H04N 23/56; H04N 23/667; H04N 23/683

(57) ABSTRACT

An imaging system includes: an illuminator that outputs illumination light to be radiated onto a target object; an imager that receives reflected light originating from the illumination light and coming from the target object and generates a compressed image in which image information of wavelength bands included in a target wavelength range is compressed as one piece of image information; and a processor that generates reconstructed images based on the compressed image, each reconstructed image corresponding to a different one of the wavelength bands. The wavelength bands include a first wavelength band and a second wavelength band. A light intensity in the first wavelength band included in the illumination light and a light intensity in the second wavelength band included in the illumination light are different from each other.

### BACKGROUND

### 1. Technical Field

The present disclosure relates to imaging systems and methods.

### 2. Description of the Related Art

By utilizing spectral information about a large number of bands, such as several tens of bands, each of which is a narrow band, detailed characteristics of a target object can be ascertained, which is not possible with a conventional RGB image having color information about three bands (i.e., red, green, and blue). A camera that acquires an image of such a large number of wavelength bands is called a “hyperspectral camera”. Hyperspectral cameras are used in various fields, such as in food inspection, biological examination, drug development, and mineral component analysis.

U.S. Pat. No. 9,599,511 discloses an example of a hyperspectral imaging device that utilizes compressed sensing. Compressed sensing is a technique involving assuming that a data distribution of an observation target is sparse in a certain space (e.g., frequency space) so as to reconstruct data greater in number than observed data. The imaging device disclosed in U.S. Pat. No. 9,599,511 includes an encoder as an array of optical filters with different spectral transmittances on an optical path that connects a target object and an image sensor. The imaging device performs a reconstruction computation based on a compressed image acquired by imaging using the encoder, so as to be capable of generating an image corresponding to each wavelength band in a single imaging process.

### SUMMARY

One non-limiting and exemplary embodiment provides a system and a method capable of enhancing the quality of an image of each wavelength band reconstructed from a compressed image acquired by an imaging device that utilizes compressed sensing.

In one general aspect, the techniques disclosed here feature an imaging system including: an illuminator that outputs illumination light to be radiated onto a target object; an imager that receives reflected light originating from the illumination light and coming from the target object to generate a compressed image in which image information of wavelength bands included in a target wavelength range is compressed as one piece of image information; and a processor that generates reconstructed images based on the compressed image, each reconstructed image corresponding to a different one of the wavelength bands. The wavelength bands include a first wavelength band and a second wavelength band. A light intensity in the first wavelength band included in the illumination light and a light intensity in the second wavelength band included in the illumination light are different from each other.

According to the technique of the present disclosure, the quality of an image of each wavelength band reconstructed from a compressed image obtained by compressing spectral information can be enhanced.

General or specific aspects of the present disclosure may be implemented as a system, a device, a method, an integrated circuit, a computer program, or a computer readable storage medium, or may be implemented as any combination of the system, the device, the method, the integrated circuit, the computer program, and the storage medium. The computer-readable storage medium may include a nonvolatile storage medium, such as a compact disc-read only memory (CD-ROM). The device may be constituted of one or more devices. If the device is constituted of two or more devices, the two or more devices may be disposed within a single apparatus, or may be disposed separately within two or more separate apparatuses. In this description and the claims, the term “device” may refer not only to a single device but also to a system formed of devices.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A schematically illustrates a configuration example of an imaging system;

FIG. 1B schematically illustrates another configuration example of the imaging system;

FIG. 1C schematically illustrates yet another configuration example of the imaging system;

FIG. 1D schematically illustrates yet another configuration example of the imaging system;

FIG. 2A schematically illustrates an example of a filter array;

FIG. 2B illustrates an example of a spatial distribution of light transmittance in each of wavelength bands included in a target wavelength range;

FIG. 2C illustrates an example of spectral transmittance of a region A1 included in the filter array illustrated in FIG. 2A;

FIG. 2D illustrates an example of spectral transmittance of a region A2 included in the filter array illustrated in FIG. 2A;

FIG. 3 is a diagram for explaining an example of the relationship between the target wavelength range and the wavelength bands included therein;

FIG. 4A is a diagram for explaining the characteristic of spectral transmittance in a certain region of the filter array;

FIG. 4B illustrates a result obtained by averaging the spectral transmittance illustrated in FIG. 4A for each wavelength band;

FIG. 5A illustrates an example of a data structure of a hyperspectral image;

FIG. 5B illustrates another example of the data structure of the hyperspectral image;

FIG. 5C illustrates yet another example of the data structure of the hyperspectral image;

FIG. 6A illustrates a color sample including stripes extending vertically and horizontally;

FIG. 6B illustrates an example of a compressed image obtained when an image of the color sample illustrated in FIG. 6A is captured by an imaging device;

FIG. 7A is a graph illustrating an example of non-uniform spectral intensity of illumination light;

FIG. 7B is a graph illustrating an example of non-uniform spectral intensity of illumination light;

FIG. 7C is a graph illustrating an example of non-uniform spectral intensity of illumination light;

FIG. 7D is a graph illustrating an example of non-uniform spectral intensity of illumination light;

FIG. 8 is a block diagram illustrating a configuration example of the imaging system;

FIG. 9 illustrates an example of mask data;

FIG. 10 is a block diagram illustrating another configuration example of the imaging system;

FIG. 11 is a flowchart illustrating an example of the operation of a processing device;

FIG. 12 illustrates an example of a method for generating an edge image;

FIG. 13 illustrates another example of the method for generating an edge image;

FIG. 14 illustrates yet another example of the method for generating an edge image;

FIG. 15 illustrates an example where the compressed image and the edge image are displayed in a superimposed manner;

FIG. 16 illustrates an example where the compressed image and the edge image are displayed side-by-side;

FIG. 17 illustrates another display example of the compressed image and the edge image;

FIG. 18 illustrates yet another display example of the compressed image and the edge image;

FIG. 19 illustrates yet another display example of the compressed image and the edge image;

FIG. 20 is a block diagram illustrating another configuration example of the imaging system;

FIG. 21 is a flowchart illustrating another example of the operation of the processing device;

FIG. 22 is a flowchart illustrating yet another example of the operation of the processing device;

FIG. 23 is a block diagram illustrating yet another configuration example of the imaging system;

FIG. 24 is a flowchart illustrating yet another example of the operation of the processing device;

FIG. 25 is a block diagram illustrating a configuration example of a system that determines an optimal spectrum of illumination light in accordance with an assumed target object;

FIG. 26 illustrates an example of spectral reflectance of the target object; and

FIG. 27 is a flowchart illustrating an example of a process executed by a processing circuit in the system illustrated in FIG. 25.

### DETAILED DESCRIPTIONS

In the present disclosure, each circuit, unit, device, member, or section or each functional block in each block diagram may entirely or partially be implemented by, for example, one or more electronic circuits containing a semiconductor device, semiconductor IC (integrated circuit), or LSI (large scale integration). The LSI or the IC may be integrated in a single chip or may be configured by combining chips. For example, the functional blocks excluding storage elements may be integrated in a single chip. Although the terms “LSI” and “IC” are used here, the terms used may change depending on the degree of integration, such that so-called “system LSI”, “VLSI” (very large scale integration), or “ULSI” (ultra large scale integration) may be used. A field programmable gate array (FPGA) to be programmed after the LSI is manufactured, or a reconfigurable logic device (RLD) that can reconfigure the connection relationship inside the LSI or that can set up the circuit sections inside the LSI can also be used for the same purpose.

Furthermore, the function or operation of each circuit, unit, device, member, or section may entirely or partially be implemented by software processing. In this case, the software is stored in a non-transitory storage medium, such as at least one ROM (read-only memory), optical disk, or hard disk drive. When the software is executed by a processor, a function specified by the software is implemented by the processor and a peripheral device. A system or a device may include one or more non-transitory storage media storing the software, a processor, and a required hardware device, such as an interface.

In this description, signals or data indicating an image, that is, a group of signals or data indicating pixel values of pixels in an image, may sometimes be simply referred to as “image”.

In the present disclosure, the term “light” refers not only to visible light (with a wavelength ranging from approximately 400 nm to approximately 700 nm), but also to an electromagnetic wave including an ultraviolet ray (with a wavelength ranging from approximately 10 nm to approximately 400 nm) and an infrared ray (with a wavelength ranging from approximately 700 nm to approximately 1 mm).

Exemplary embodiments of the present disclosure will be described below in more detail. The embodiments to be described below indicate general or specific examples. Numerical values, shapes, components, positions and connection methods of the components, steps, and the sequence of the steps indicated in the following embodiments are examples and are not intended to limit the scope of the present disclosure. Of the components in the following embodiments, a component not defined in the independent claim indicating the most generic concept is described as any component. Furthermore, the drawings are not necessarily exact illustrations. In each drawing, same reference signs are given to substantially identical components, and redundant descriptions may sometimes be omitted or simplified.

### 1. Imaging System

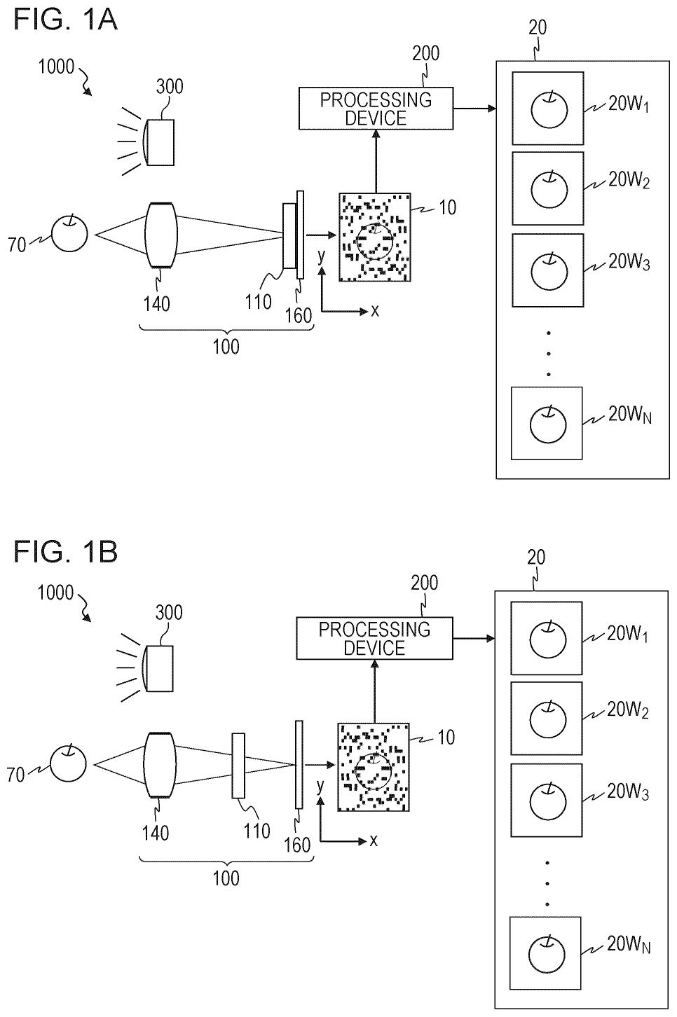

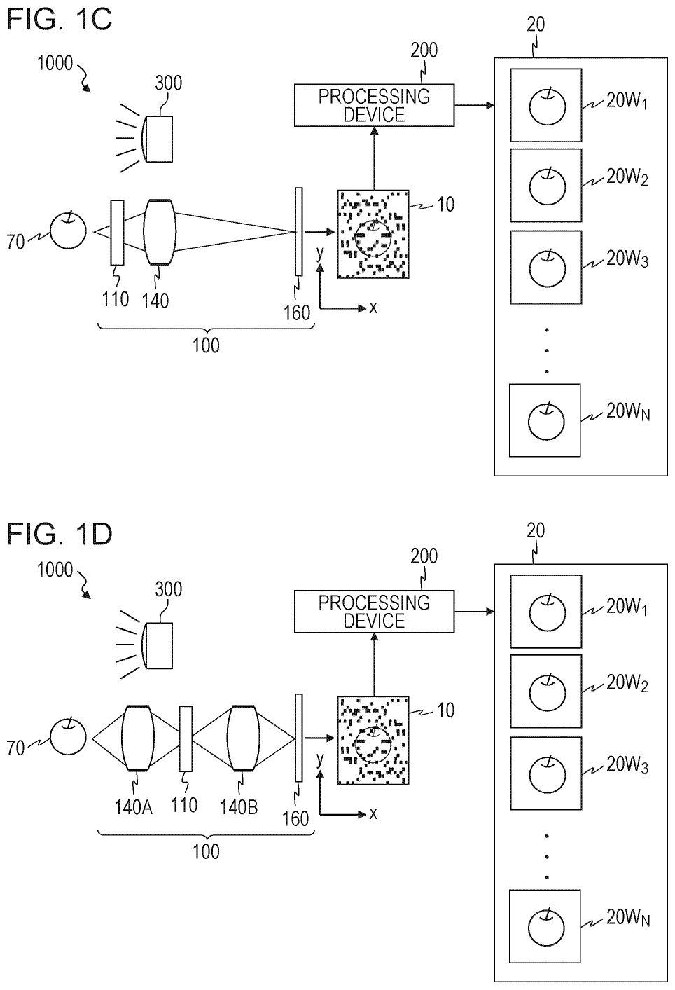

FIG. 1A schematically illustrates a configuration example of an imaging system 1000 according to an exemplary embodiment of the present disclosure. The imaging system 1000 illustrated in FIG. 1A includes an imaging device 100, a processing device 200, and an illuminating device 300. The imaging device 100 has a configuration similar to that of the imaging device disclosed in U.S. Pat. No. 9,599,511. The imaging device 100 includes an optical system 140, a filter array 110, and an image sensor 160. The optical system 140 and the filter array 110 are disposed on an optical path of light incident from a target object 70 serving as a subject. The filter array 110 in the example in FIG. 1A is disposed between the optical system 140 and the image sensor 160.

FIG. 1A illustrates an apple as an example of the target object 70. The target object 70 is not limited to an apple and may be any object. The target object 70 is irradiated with illumination light from the illuminating device 300 so that an image of the target object 70 is captured by the imaging device 100. The image sensor 160 generates data of a compressed image 10 by compressing image information about wavelength bands included in a preset target wavelength range as two-dimensional monochrome image information. Based on the data of the compressed image 10 generated by the image sensor 160, the processing device 200 generates data indicating images having a one-to-one correspondence relationship with the wavelength bands included in the target wavelength range. It is assumed here that the number of wavelength bands included in the target wavelength range is defined as N (where N is an integer greater than or equal to 4). In the following description, the N images generated based on the compressed image 10 will be referred to as reconstructed images 20W₁, 20W₂, . . . , and 20W_{N}, and may be collectively referred to as “hyperspectral image 20” or simply as “spectral image”.

The filter array 110 according to this embodiment is an optical element including translucent filters arranged in a row-by-column matrix. The filters include multiple types of filters with different spectral transmittances. Spectral transmittance indicates the wavelength dependency with respect to transmittance and is also referred to as a transmission spectrum. The filter array 110 modulates and outputs the intensity of incident light for each wavelength. This process by the filter array 110 is also referred to as “encoding”. The filter array 110 may sometimes be referred to as an “encoder” or an “encoding mask”.

In the example illustrated in FIG. 1A, the filter array 110 is disposed close to or directly on the image sensor 160. The expression “close to” implies that the filter array 110 is close to the image sensor 160 to an extent that an image of light from the optical system 140 is formed on a surface of the filter array 110 in a state where the image is clear to a certain extent. The expression “directly on” implies that the two are close to each other with hardly any gap therebetween. The filter array 110 and the image sensor 160 may be integrated with each other.

The optical system 140 includes at least one lens. Although the optical system 140 is illustrated as a single lens in FIG. 1A, the optical system 140 may be constituted of a combination of lenses. The optical system 140 forms an image on an imaging surface of the image sensor 160 via the filter array 110.

The filter array 110 may be disposed away from the image sensor 160. FIGS. 1B to 1D each illustrate a configuration example of the imaging device 100 in which the filter array 110 is disposed away from the image sensor 160. In the example in FIG. 1B, the filter array 110 is disposed at a position located between the optical system 140 and the image sensor 160 and away from the image sensor 160. In the example in FIG. 1C, the filter array 110 is disposed between the target object 70 and the optical system 140. In the example in FIG. 1D, the imaging device 100 includes two optical systems 140A and 140B, and the filter array 110 is disposed therebetween. As in these examples, an optical system including at least one lens may be disposed between the filter array 110 and the image sensor 160.

The image sensor 160 is a monochrome-type light detector having two-dimensionally-arranged light detection elements (also referred to as “pixels” in this description). The image sensor 160 may be, for example, a CCD (charge-coupled device) sensor, a CMOS (complementary metal oxide semiconductor) sensor, or an infrared array sensor. The light detection elements may include, for example, photodiodes. The image sensor 160 may be, for example, a color-type sensor. The color-type sensor may include red (R) filters that transmit red light, green (G) filters that transmit green light, and blue (B) filters that transmit blue light. The color-type sensor may further include IR filters that transmit infrared rays. The color-type sensor may further include transparent filters that transmit all of red light, green light, and blue light. By using the color-type sensor, the amount of wavelength-related information can be increased, so that the accuracy for reconstructing the hyperspectral image 20 can be enhanced. The wavelength range of the acquisition target may be set arbitrarily and is not limited to a visible wavelength range. The wavelength range of the acquisition target may be an ultraviolet, near-infrared, mid-infrared, or far-infrared wavelength range.

The processing device 200 may be a computer including at least one processor and at least one storage medium, such as a memory. The processing device 200 generates data of the reconstructed images 20W₁, 20W₂, . . . , and 20W_{N} based on the compressed image 10 acquired by the image sensor 160.

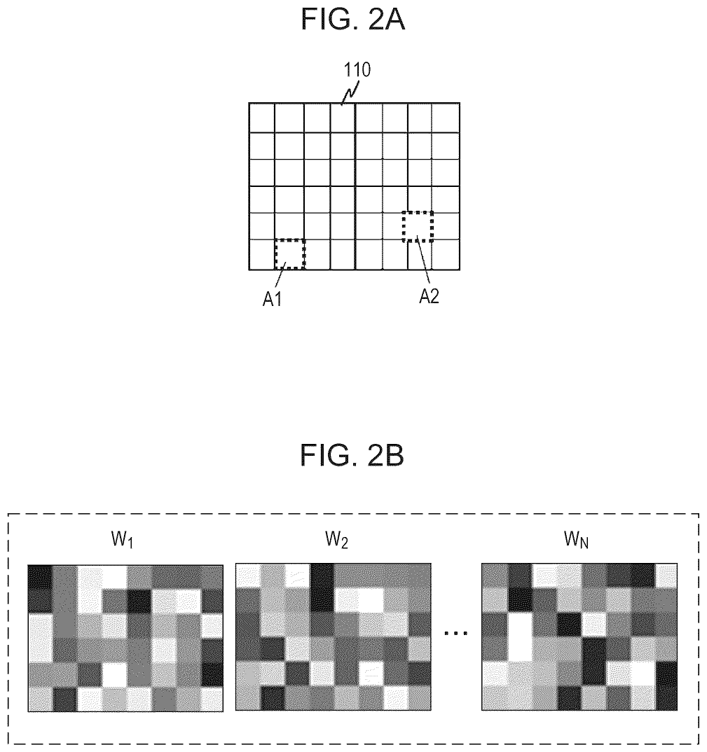

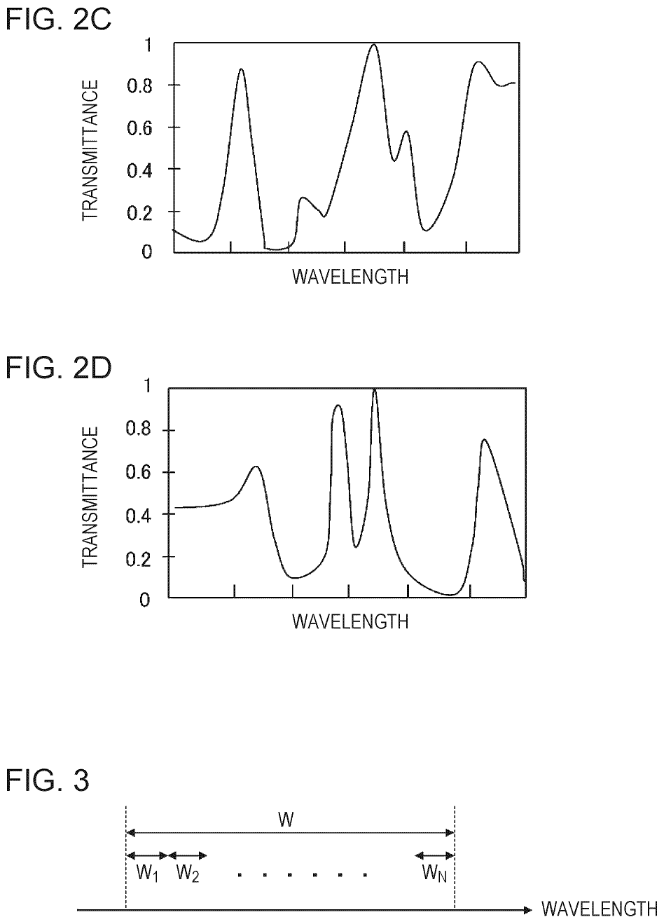

FIG. 2A schematically illustrates an example of the filter array 110. The filter array 110 has two-dimensionally-arranged regions. In this description, these regions may sometimes be referred to as “cells”. Each region has an optical filter having individually-set spectral transmittance. Spectral transmittance is expressed with a function T (2), where λ denotes the wavelength of incident light. The spectral transmittance T (2) may have a value greater than or equal to 0 and less than or equal to 1.

In the example illustrated in FIG. 2A, the filter array 110 has 48 rectangular regions arranged in a 6 row by 8 column matrix. This is merely an example, and a larger number of regions may be set in an actual application. For example, the number may be about the same as the number of pixels in the image sensor 160. The number of filters included in the filter array 110 is set in accordance with the intended usage within a range of, for example, several tens to several thousands of filters.

FIG. 2B illustrates an example of a spatial distribution of light transmittance for each of wavelength bands W₁, W₂, . . . , and W_{N} included in the target wavelength range. In the example illustrated in FIG. 2B, the differences in the gradation levels of the regions indicate differences in transmittance. A paler region has higher transmittance, whereas a darker region has lower transmittance. As illustrated in FIG. 2B, the spatial distribution of light transmittance varies from wavelength band to wavelength band.

FIGS. 2C and 2D illustrate examples of spectral transmittance in a region A1 and a region A2 included in the filter array 110 illustrated in FIG. 2A. The spectral transmittance in the region A1 and the spectral transmittance in the region A2 are different from each other. Accordingly, the spectral transmittance of the filter array 110 varies from region to region. However, not all the regions need to have different spectral transmittances. In the filter array 110, at least some of the regions have different spectral transmittances. The filter array 110 includes at least two filters with different spectral transmittances. In one example, the number of spectral transmittance patterns of the regions included in the filter array 110 may be equal to or greater than the number N of wavelength bands included in the target wavelength range. The filter array 110 may be designed such that at least half of the regions have different spectral transmittances.

FIG. 3 is a diagram for explaining the relationship between a target wavelength range W and the wavelength bands W₁, W₂, . . . , and W_{N} included therein. The target wavelength range W may be set to any of various ranges in accordance with the intended usage. For example, the target wavelength range W may be a visible-light wavelength range from approximately 400 nm to approximately 700 nm, a near-infrared wavelength range from approximately 700 nm to approximately 2500 nm, or a near-ultraviolet wavelength range from approximately 10 nm to approximately 400 nm. Alternatively, the target wavelength range W may be a wavelength range such as a mid-infrared range or a far-infrared range. Accordingly, the wavelength range to be used is not limited to a visible-light range. In this description, radiation in general, including an infrared ray and an ultraviolet ray, in addition to visible light, will be referred to as “light”.

In the example illustrated in FIG. 3, the target wavelength range W is equally divided by N into wavelength bands W₁, W₂, . . . , and W_{N}, where N denotes any integer greater than or equal to 4. However, the example is not limited to this. The wavelength bands included in the target wavelength range W may be set arbitrarily. For example, the bandwidths may be non-uniform among the wavelength bands. The method of how the wavelength bands are set is arbitrary.

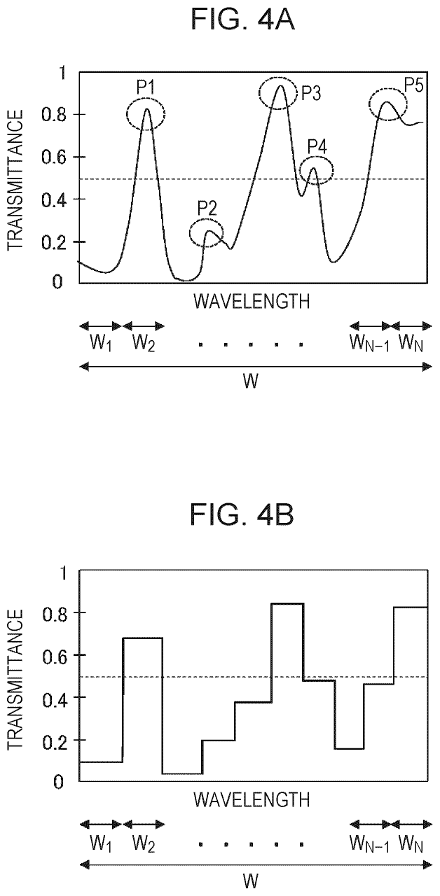

FIG. 4A is a diagram for explaining the characteristic of spectral transmittance in a certain region of the filter array 110. In the example illustrated in FIG. 4A, the spectral transmittance has local maximum values P1 to P5 and local minimum values with respect to wavelengths within the target wavelength range W. In the example illustrated in FIG. 4A, the light transmittance within the target wavelength range W is normalized such that the maximum value thereof is 1 and the minimum value thereof is 0. In the example illustrated in FIG. 4A, the spectral transmittance has local maximum values in wavelength bands such as the wavelength band W₂ and the wavelength band W_{N-1}. Accordingly, the spectral transmittance in each region may be designed to have local maximum values in at least two wavelength bands among the wavelength bands W₁, W₂, . . . , and W_{N}. In the example in FIG. 4A, the local maximum values P1, P3, P4, and P5 are greater than or equal to 0.5.

Accordingly, the light transmittance in each region varies from wavelength to wavelength. Therefore, the filter array 110 transmits a large amount of incident light in certain wavelength bands and does not transmit much of the incident light in other wavelength bands. For example, the transmittance with respect to light in k wavelength bands among the N wavelength bands may be higher than 0.5, whereas the transmittance with respect to light in the remaining (N-k) wavelength bands may be lower than 0.5. In this case, k denotes an integer satisfying the relationship 2≤k<N. Supposing that the incident light is white light uniformly containing all wavelength components of visible light, the filter array 110 modulates the incident light into light having discrete intensity peaks with respect to the wavelengths for each region, superimposes the multi-wavelength light, and outputs the light.

FIG. 4B illustrates an example of a result obtained by averaging the spectral transmittance illustrated in FIG. 4A for each of the wavelength bands W₁, W₂, . . . , and W_{N}. Averaged transmittance is obtained by integrating the spectral transmittance T(λ) for each wavelength band and dividing the integral value by the bandwidth of the wavelength band. In this description, a transmittance value averaged for each wavelength band in this manner will be referred to as transmittance in that wavelength band. In this example, transmittance is outstandingly high in the three wavelength bands having the local maximum values P1, P3, and P5. In particular, the transmittance exceeds 0.8 in the two wavelength bands having the maximum values P3 and P5.

In the examples illustrated in FIG. 2A to FIG. 2D, a gray-scale transmittance distribution is assumed in which the transmittance in each region may be any value that is greater than or equal to 0 and less than or equal to 1. However, such a gray-scale transmittance distribution is not necessarily essential. For example, a binary-scale transmittance distribution in which the transmittance in each region may be a value of either substantially 0 or substantially 1 may be employed. In a binary-scale transmittance distribution, each region transmits a large amount of light in at least two wavelength bands of the wavelength bands included in the target wavelength range, and does not transmit much of the light in the remaining wavelength bands. The expression “large amount” refers to substantially 80% or higher.

Of all the cells, some of them, such as half of the cells, may be replaced with transparent regions. Such transparent regions transmit light in the wavelength bands W₁, W₂, . . . , and W_{N} included in the target wavelength range W with about the same high transmittance. For example, the high transmittance is higher than or equal to 80%. In such a configuration, the transparent regions may be arranged in, for example, a checkerboard pattern. In other words, in two arrangement directions of the regions in the filter array 110, regions with different light transmittances depending on the wavelength and transparent regions may be alternately arranged.

Such data indicating the spatial distribution of the spectral transmittance of the filter array 110 is preliminarily acquired based on design data or actual measurement calibration, and is stored in a storage medium included in the processing device 200. The data is used in a computation process to be described later.

The filter array 110 may be constituted by using, for example, a multilayer film, an organic material, a diffraction grating structure, or a metal-containing micro-structure. In a case where a multilayer film is used, for example, a dielectric multilayer film or a multilayer film including a metallic layer may be used. In this case, the filter array 110 may be formed such that at least one of the thickness, the material, or the stacked order of each multilayer film varies for each cell. Accordingly, spectral properties that vary from cell to cell can be realized. By using a multilayer film, sharp rising and falling in spectral transmittance can be realized. A configuration that uses an organic material may be realized by varying a contained pigment or dye from cell to cell, or by stacking different types of materials. A configuration that uses a diffraction grating structure may be realized by providing a diffracting structure with a diffraction pitch or depth that varies from cell to cell. In a case where a metal-containing micro-structure is used, the filter array 110 may be fabricated by utilizing spectroscopy based on a plasmon effect.

Next, an example of signal processing performed by the processing device 200 will be described. The processing device 200 reconstructs the multi-wavelength hyperspectral image 20 based on the compressed image 10 output from the image sensor 160 and the spatial distribution characteristics of transmittance at each wavelength of the filter array 110. The term “multi-wavelength” refers to, for example, wavelength bands greater in number than the wavelength bands of the three colors, namely, RGB, acquired by a normal color camera. The number of wavelength bands may be, for example, about 4 to 100. The number of wavelength bands will be referred to as “number of bands”. Depending on the intended usage, the number of bands may exceed 100.

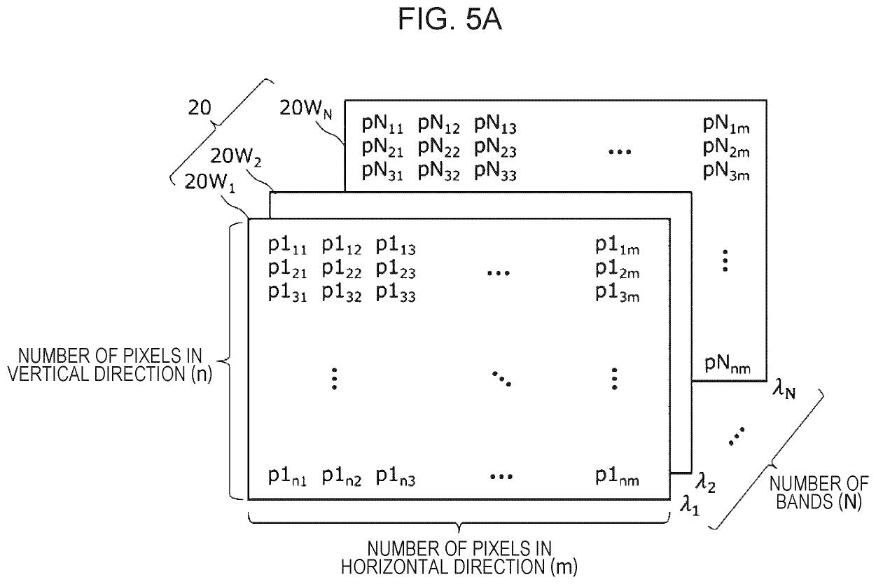

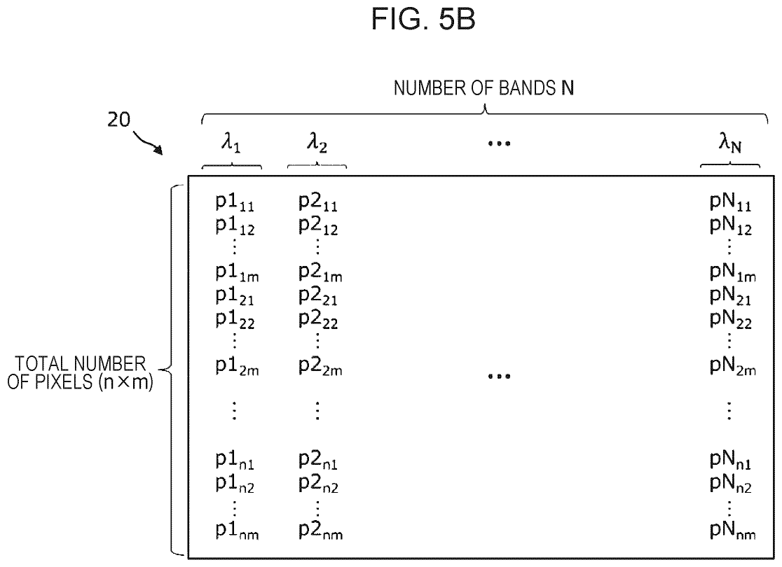

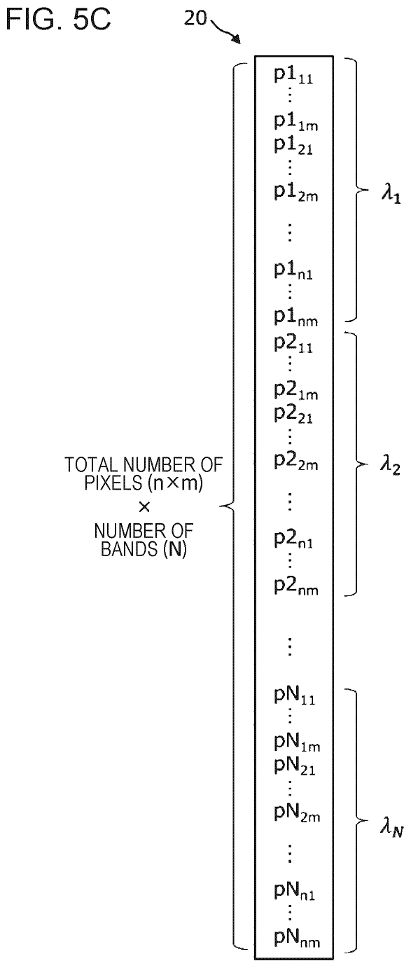

FIG. 5A illustrates an example of the data structure of the hyperspectral image 20. In the example in FIG. 5A, the hyperspectral image 20 is expressed as a group of N images 20W₁, 20 W₂, . . . , and 20W_{N}. The data of the hyperspectral image 20 having such a structure is referred to as “hyperspectral data cube”. A k-th image 20Wₖ corresponds to a k-th wavelength band 2, where k=1, 2, . . . , or k. In this case, a center wavelength λx of the k-th wavelength band is used as a reference sign indicating the k-th wavelength band. With regard to each of the images 20W₁, 20W₂, . . . , and 20W_{N}, the number of pixels in the horizontal direction is defined as m, the number of pixels in the vertical direction is defined as n, and a pixel value of the pixel in the i-th row and the j-th column in the k-th image 20Wₖ is defined as pkij. Thus, the hyperspectral image 20 can be expressed by N n×m matrices indicated below.

$$( \begin{matrix}p {1}_{11} & … & p {1}_{1 m} \\ ⋮ & ⋱ & ⋮ \\ p {1}_{n 1} & … & p {1}_{n m}\end{matrix} ) , ( \begin{matrix}p {2}_{11} & … & p {2}_{1 m} \\ ⋮ & ⋱ & ⋮ \\ p {2}_{n 1} & … & p {2}_{n m}\end{matrix} ) , ( \begin{matrix}p {N}_{11} & … & p {N}_{1 m} \\ ⋮ & ⋱ & ⋮ \\ p {N}_{n 1} & … & p {N}_{n m}\end{matrix} ) ,$$

The hyperspectral image 20 is not limited to the three-dimensional-array data structure as illustrated in FIG. 5A, and may have, for example, a two-dimensional-array data structure as illustrated in FIG. 5B or a one-dimensional-array data structure as illustrated in FIG. 5C. In the example in FIG. 5B, pieces of information about N wavelength-band images are arranged in the horizontal direction, and pixel values of n×m pixels in each wavelength-band image are arranged in the vertical direction. In the example in FIG. 5C, pixel values of all pixels in all of the wavelength-band images are arranged in a single column. Accordingly, the data structure of the hyperspectral image 20 is arbitrary.

The data of the hyperspectral image 20 generated by the processing device 200 is defined as f. The data f is obtained by integrating data f₁, f₂, . . . , and f_{N} of N bands. The data f₁, f₂, . . . , and f_{N} each have n×m pixel values. Therefore, the data f is data in which the number of elements is n×m×N. On the other hand, the number of elements in data g of the compressed image 10 acquired as a result of encoding and multiplexing by the filter array 110 is n×m. The data g can be expressed by Expression (1) indicated below.

$$g = Hf = H [ \begin{matrix}{f}_{1} \\ {f}_{2} \\ ⋮ \\ {f}_{N}\end{matrix} ] \qquad ( 1 )$$

The data f in Expression (1) indicates hyperspectral image data expressed as a one-dimensional vector, as illustrated in FIG. 5C. The data f₁, f₂, . . . , and f_{N} each have n×m elements. Therefore, the right-hand-side vector is a one-dimensional vector of n×m×N rows by 1 column. The data g of the compressed image is calculated as a one-dimensional vector of n×m rows by 1 column. A matrix H represents a transformation involving encoding and intensity-modulating the components f₁, f₂, . . . , and f_{N} of the vector f based on encoding information that varies from wavelength band to wavelength band and adding them together. Therefore, H is an n×m row by n×m×N column matrix. Expression (1) can also be expressed as follows:

$$g = {( p {g}_{11} … {pg}_{1 m} … {pg}_{n 1} … {pg}_{n m} )}^{T} = {H ( {f}_{1} … {f}_{N} )}^{T} \qquad ( 1 )$$

where pgᵢⱼ denotes a pixel value in the i-th row and the j-th column of the compressed image 10.

The data indicating the matrix H may be created prior to a reconstruction computation and be stored in a storage device, such as the memory, of the processing device 200.

With the vector g and the matrix H provided, the data f appears as if it can be calculated by solving an inverse problem of Expression (1). However, since the number of elements n×m×N in the data f to be determined is larger than the number of elements n×m in the acquired data g, this problem is an ill-posed problem and cannot be solved as-is. In view of this, the processing device 200 utilizes the redundancy of the images contained in the data f to determine the solution by using compressed sensing. In detail, the data f to be determined is estimated by solving Expression (2) indicated below.

$${f}^{′} = {arg min}_{f} \{ {‖ g - Hf ‖}_{{i}_{2}} + τϕ ( f ) \} \qquad ( 2 )$$

In this case, f denotes estimated data of f. The first term within the parentheses in the above expression indicates a deviation between an estimation result Hf and the acquired data g and represents a so-called residual term. Although a sum of squares is the residual term, an absolute value or a root mean square may be the residual term. The second term within the parentheses is a regularization term or a stabilization term. Expression (2) involves determining f that minimizes the sum of the first term and the second term. The function within the parentheses in Expression (2) is referred to as an evaluation function. The processing device 200 can converge to a solution by a recursive iterative computation so as to calculate f that minimizes the evaluation function as an ultimate solution f.

The first term within the parentheses in Expression (2) indicates a computation for determining the sum of squares of a difference between the acquired data g and Hf obtained by transforming f in the estimation process in accordance with the matrix H. @ (f) in the second term indicates a constraint condition in the regularization of f, and is a function reflecting the sparse information of the estimated data. This function brings about an effect that smoothens or stabilizes the estimated data. A regularization term can be expressed by, for example, discrete cosine transform (DCT) of f, wavelet transform, Fourier transform, or total variation (TV). For example, when total variation is used, stable estimated data with a reduced effect of noise in the observational data g can be acquired. The sparsity of the target object 70 in the space of the regularization term varies depending on the texture of the target object 70. A regularization term where the texture of the target object 70 becomes more sparse in the space of the regularization term may be selected. Alternatively, multiple regularization terms may be included in the computation. t denotes a weighting factor. The amount of reduction in redundant data increases with increasing weighting factor t, resulting in a higher compression ratio. The convergence to the solution weakens with decreasing weighting factor t. The weighting factor t is set to an appropriate value at which f converges to a certain extent and at which excessive compression does not occur.

In the configuration in each of FIG. 1B and FIG. 1C, an image encoded by the filter array 110 may be acquired in a blurred state on the imaging surface of the image sensor 160. In this case, the blur information may be retained in advance, and this blur information may be reflected on the matrix H mentioned above, so that the hyperspectral image 20 can be reconstructed. The blur information is expressed by a point spread function (PSF). A PSF is a function that defines the degree of spreading of a point image to surrounding pixels. For example, if a point image corresponding to one pixel of an image blurs and thus spreads to a k×k pixel region surrounding the image, the PSF may be defined as a coefficient group, that is, a matrix, indicating the effect on the pixel values of the pixels within the region. By reflecting the effect of blurring of an encoding pattern by the PSF onto the matrix H, the hyperspectral image 20 with reduced blur can be reconstructed. Although the position where the filter array 110 is disposed is arbitrary, a position where the encoding pattern of the filter array 110 does not disappear due to excessive diffusion may be selected.

As a result of the above process, the hyperspectral image 20 can be reconstructed from the compressed image 10 acquired by the image sensor 160. The details of the reconstruction method of the hyperspectral image 20 are disclosed in U.S. Pat. No. 9,599,511. The entire disclosure of U.S. Pat. No. 9,599,511 is incorporated by reference into this description.

In the above example, the processing device 200 reconstructs the hyperspectral image 20 based on the data of the compressed image 10 output from the image sensor 160. As an alternative to the processing device 200, a processor in the imaging device 100 may perform the process for reconstructing the hyperspectral image 20. As another alternative, an external computer, such as a cloud server, communicating with the imaging device 100 via a network may perform the process for reconstructing the hyperspectral image 20 based on the data of the compressed image 10 acquired by the imaging device 100.

Next, another configuration example of the imaging device 100 will be described. A compressed image and a hyperspectral image may be generated by performing imaging based on a method different from the imaging using the filter array 110, i.e., an encoding mask, including the aforementioned optical filters.

For example, as the configuration of the imaging device 100, the light-receiving properties of the image sensor 160 may be varied for each pixel by performing processing on the image sensor 160. Similar to the above example, a compressed image can be generated by imaging using the processed image sensor 160. Specifically, a compressed image may be generated by an imaging device having the filter array 110 contained in the image sensor 160. In this case, the encoding information corresponds to the light-receiving properties of the image sensor 160.

Another configuration that may be employed involves incorporating an optical element, such as a meta-lens, into at least a part of the optical system 140, so that the optical properties of the optical system 140 change spatially and spectrally, whereby the spectral information is compressed. A compressed image can also be generated by an imaging device including such a configuration. In this case, the encoding information corresponds to the optical properties of the optical element, such as a meta-lens. Accordingly, the imaging device 100 having a configuration different from the configuration using the filter array 110 may be used to modulate the intensity of the incident light for each wavelength and to generate the compressed image 10 and the hyperspectral image 20.

In other words, the present disclosure encompasses a configuration that generates a reconstructed image, including signals larger in number than the signals (e.g., pixels) included in the compressed image 10, based on encoding information corresponding to light response properties of the imaging device 100 including light-receiving regions having light response properties different from each other and also based on the compressed image 10 generated by the imaging device 100. As mentioned above, the light response properties may correspond to the light-receiving properties of the image sensor, or may correspond to the optical properties of the optical element.

### 2. Imaging Using Non-Uniform Illumination

In the above-described imaging system that reconstructs a hyperspectral image based on a compressed image, imaging is performed using illumination light with uniform spectral intensity. This is because when the intensity of the illumination light greatly varies depending on the wavelength, the intensity of light entering each pixel of the image sensor greatly differs between wavelengths, thus resulting in a decrease in reconstruction accuracy. For example, when there is a large difference in the intensity of the illumination light between the wavelength bands included in the target wavelength range, the magnitude of the elements of the data f in Expression (1) indicated above greatly varies between the bands, thus resulting in a strong effect of noise. This conceivably decreases the reconstruction accuracy. Therefore, the illuminating device 300 illustrated in FIG. 1A to FIG. 1D is configured to output illumination light with uniform spectral intensity.

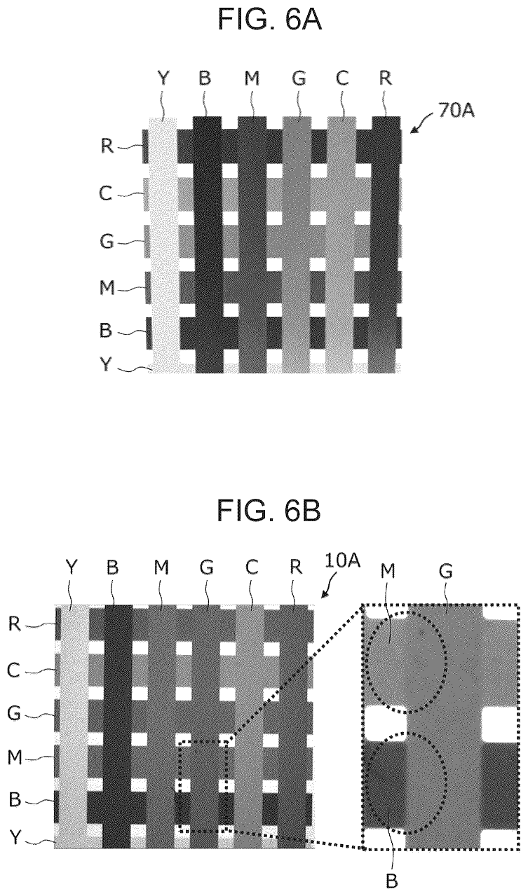

However, the present inventors have found that, when imaging is performed by using illumination light with uniform spectral intensity, the edges at color boundaries in the compressed image to be acquired become unclear depending on the target object, thus resulting in a decrease in reconstruction accuracy. This problem will be described with reference to FIG. 6A and FIG. 6B.

FIG. 6A illustrates a color sample 70A including stripes that extend vertically and horizontally. FIG. 6B illustrates an example of a compressed image 10A obtained when an image of the color sample 70A illustrated in FIG. 6A is captured by the aforementioned imaging device 100. FIG. 6B illustrates the compressed image 10A at the left side and a partially extended view thereof at the right side. The compressed image 10A illustrated in FIG. 6B is obtained as a result of the illuminating device 300 performing imaging by outputting illumination light with uniform spectral intensity.

The color sample 70A illustrated in FIG. 6A includes six different-colored stripes extending in the vertical direction and six different-colored stripes extending in the horizontal direction. The colors of the stripes extending in the vertical direction are yellow (Y), blue (B), magenta (M), green (G), cyan (C), and red (R) in left-to-right order. The colors of the stripes extending in the horizontal direction are red (R), cyan (C), green (G), magenta (M), blue (B), and yellow (Y) in top-to-bottom order. Each colored stripe extending in the horizontal direction is connected to the same-colored stripe extending in the vertical direction and is located behind the different-colored stripes extending in the vertical direction.

When an image of the color sample 70A illustrated in FIG. 6A is captured by illuminating it with illumination light with a uniform spectrum, the compressed image 10A as illustrated in FIG. 6B is acquired. The right side of FIG. 6B illustrates an enlarged view of a region surrounded by a dotted frame in FIG. 6B. In the compressed image 10A, a difference between brightness values in the green (G) region and the magenta (M) region is small, so that the boundary between these regions is unclear. On the other hand, the boundary between the green (G) region and the blue (B) region is clear.

Accordingly, in the compressed image 10A, the boundary between two regions that should have different colors is sometimes unclear. In this case, the reconstruction accuracy of a hyperspectral image based on the compressed image 10A decreases. For example, a problem may occur such that a color boundary blurs in a reconstructed image.

The present inventors have challenged such a new problem and have studied a configuration of an imaging system for solving this problem. The present inventors have found that the aforementioned problem may be solved by purposefully performing imaging using the illuminating device 300 that outputs illumination light with non-uniform spectral intensity.

Specifically, the illuminating device 300 according to this embodiment is configured to output illumination light with non-uniform spectral intensity. The expression “non-uniform spectral intensity” implies that the light intensity varies between at least two of the wavelength bands included in the target wavelength range. Specifically, in a case where the wavelength bands included in the target wavelength range includes a first wavelength band and a second wavelength band, the light intensity in the first wavelength band included in the illumination light and the light intensity in the second wavelength band included in the illumination light are different from each other. The light intensity in an i-th wavelength band (where i is an integer greater than or equal to 1) may be an average value related to the wavelength of the light intensity in the i-th wavelength band. The expression “the light intensities in the two wavelength bands are different from each other” implies that the difference in light intensity is greater than 20% of the light intensity in the wavelength band with the higher intensity. The light intensity in the first wavelength band and the light intensity in the second wavelength band may be different from each other by 30% or more, or by 40% or more.

The target wavelength range may be a wavelength range serving as a target for image reconstruction or a wavelength range of light serving as a target to be detected by the image sensor. For example, if each band has a bandwidth of 10 nm and each of images of 30 bands ranging from 400 nm to 410 nm, 410 nm to 420 nm, . . . , and 690 nm to 700 nm is to be reconstructed from a compressed image, the target wavelength range may be 400 nm to 700 nm. In a case where light with a wavelength shorter than 500 nm and light with a wavelength longer than 800 nm are removed by the filter array 110 included in the imaging device 100 or by another filter (e.g., bandpass filter) and light detected by the image sensor 160 ranges from 500 nm to 800 nm, the target wavelength range may range from 500 nm to 800 nm.

By using illumination light with non-uniform spectral intensity, an unclear color boundary that should originally exist in a compressed image can be suppressed, so that a decrease in reconstruction accuracy can be suppressed.

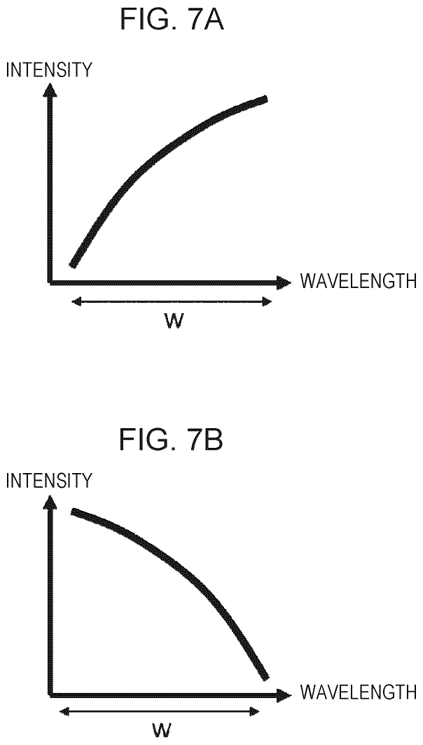

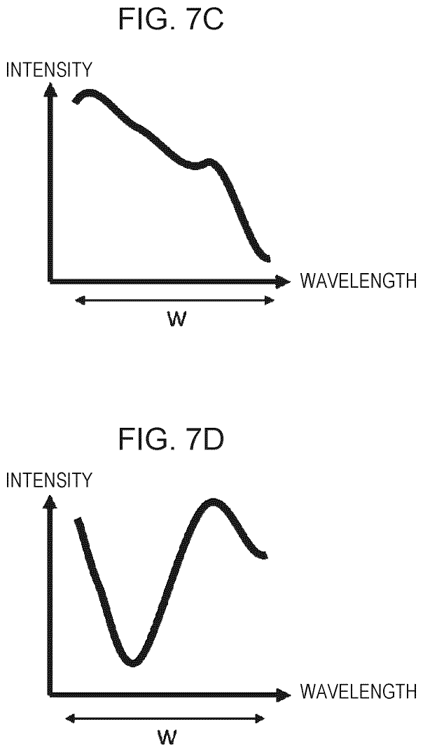

FIG. 7A to FIG. 7D are graphs each indicating an example of non-uniform spectral intensity of illumination light. FIG. 7A illustrates an example of spectral intensity of illumination light whose intensity increases monotonically in accordance with an increase in wavelength in the target wavelength range W. FIG. 7B illustrates an example of spectral intensity of illumination light whose intensity decreases monotonically in accordance with an increase in wavelength. FIG. 7C illustrates an example of spectral intensity of illumination light whose intensity decreases in accordance with an increase in wavelength except for a part of the wavelength range. FIG. 7D illustrates an example of spectral intensity of illumination light whose intensity fluctuates significantly in accordance with an increase in wavelength. As illustrated in these drawings, the spectral intensity of the illumination light output from the illuminating device 300 may vary. The spectral intensity of the illumination light is appropriately determined in accordance with the reflection properties of the target object.

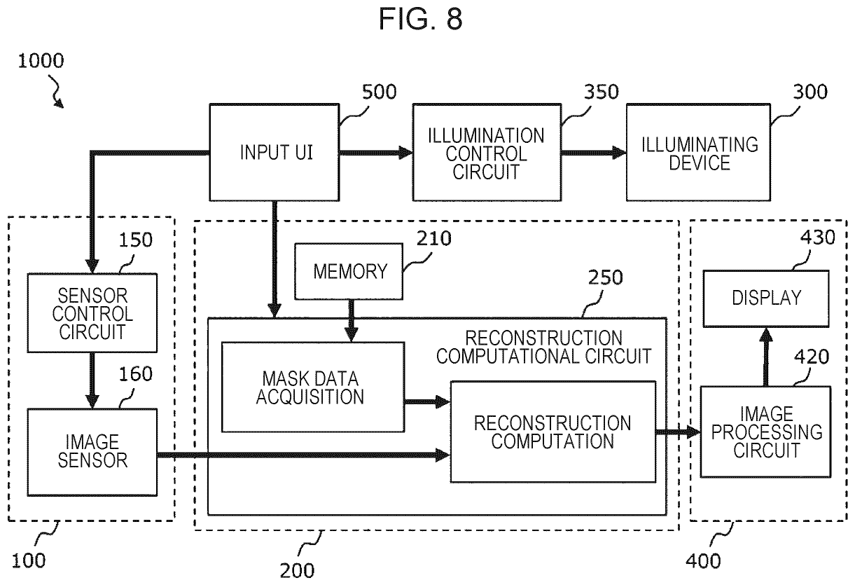

FIG. 8 is a block diagram illustrating a more detailed configuration example of the imaging system 1000 according to this embodiment. The imaging system illustrated in FIG. 8 includes the imaging device 100, the processing device 200, an illumination control circuit 350, the illuminating device 300, a display device 400, and an input user interface (UI) 500.

The imaging device 100 includes the image sensor 160 and a sensor control circuit 150 that controls the image sensor 160. Although not illustrated in FIG. 8, the imaging device 100 also includes the filter array 110 and at least one optical system 140, as illustrated in FIG. 1A to FIG. 1D. The layout of the filter array 110 and the optical system 140 may be any of the layouts in FIG. 1A to FIG. 1D. The filter array 110 is an example of an optical element including regions with different transmission spectra. The image sensor 160 receives light whose intensity has been modulated in accordance with each region by the filter array 110, and acquires a monochrome image, that is, a compressed image, based on the light. The pixel values of the compressed image have superimposed thereon information about the wavelength bands included in the target wavelength range.

The processing device 200 includes a reconstruction computational circuit 250 and a memory 210, such as a random access memory (RAM) and a read only memory (ROM). The reconstruction computational circuit 250 is an integrated circuit including at least one processor, such as a central processing unit (CPU) or a graphics processing unit (GPU). The reconstruction computational circuit 250 performs a reconstruction computation based on the compressed image output from the image sensor 160. The reconstruction computation corresponds to the computation indicated in Expression (2) indicated above.

In the example illustrated in FIG. 8, photographic and reconstruction processes are performed in accordance with a command input from the input UI 500. The reconstruction computational circuit 250 executes the reconstruction computation with respect to all of the wavelength bands included in the target wavelength range or with respect to one or more of the wavelength bands designated via the input UI. The memory 210 stores a computer program executed by a processor included in the reconstruction computational circuit 250, various types of data available for reference by the reconstruction computational circuit 250, and various types of data generated by the reconstruction computational circuit 250. The memory 210 stores mask data reflecting the spatial distribution of the spectral transmittance of the filter array 110 in the imaging device 100. The mask data contains information indicating the matrix in each of Expressions (1) and (2) indicated above or information (also referred to as “mask matrix information”) for deriving the matrix. The mask matrix information may be matrix-format or a matrix-compliant-format information having elements corresponding to the spatial distribution of the transmittance of the filter array 110 with respect to each of the unit bands included in the target wavelength range. The mask data is created in advance and is stored in the memory 210.

The illuminating device 300 outputs illumination light to be radiated onto the target object. The illuminating device 300 includes at least one light source. The illuminating device 300 may include an optical filter that modulates the intensity of the light output from the light source in accordance with the wavelength. The illuminating device 300 may be configured to output illumination light having non-uniform spectral intensity that emphasizes the edges of the target object in the compressed image. The illuminating device 300 may have a configuration that changes the spectrum of the illumination light. For example, the illuminating device 300 may include multiple types of light sources with different light emission spectra. Alternatively, the illuminating device 300 may include optical filters with different transmission spectra and a mechanical mechanism that inserts one optical filter selected from the optical filters into the optical path of the illumination light.

The illumination control circuit 350 controls the operation of the illuminating device 300. The illumination control circuit 350 causes the illuminating device 300 to output illumination light in synchronization with the imaging by the image sensor 160. When receiving a photographic command from the input UI 500, the illumination control circuit 350 causes the illuminating device 300 to output illumination light. The illumination control circuit 350 is independent of the processing device 200 in the example in FIG. 8, but may be included in the processing device 200.

The display device 400 includes an image processing circuit 420 and a display 430. The image processing circuit 420 performs required processing on an image reconstructed by the reconstruction computational circuit 250 and causes the display 430 to display the image. The display 430 may be any display, such as a liquid crystal display or an organic LED display.

The input UI 500 includes hardware and software used by a user for issuing a photographic command or for setting various conditions, such as an imaging condition and a reconstruction condition. The input UI 500 may include an input device, such as a keyboard and a mouse. The input UI 500 may be realized by a device that enables both input and output, such as a touchscreen. In that case, the touchscreen may also function as the display 430. The imaging condition may include conditions, such as resolution, gain, and exposure time. The reconstruction condition may include conditions, such as a condition for designating wavelength bands targeted for reconstruction and the number of calculations. The input imaging condition is sent to the control circuit 150 of the imaging device 100. The control circuit 150 causes the image sensor 160 to execute imaging in accordance with the imaging condition. Accordingly, the image sensor 160 generates a compressed image. The input reconstruction condition is sent to the reconstruction computational circuit 250. The reconstruction computational circuit 250 acquires the mask data from the memory 210 in accordance with the set reconstruction condition, and performs a reconstruction process based on the mask data and the compressed image. Accordingly, the reconstruction computational circuit 250 generates a spectral image (i.e., reconstructed image) with respect to each of the designated wavelength bands.

The generated spectral image is sent to the image processing circuit 420. The image processing circuit 420 causes the display 430 to display the reconstructed image with respect to each of the wavelength bands. For example, the image processing circuit 420 may perform processes, such as layout setting on the screen, association with band information, and color addition corresponding to the wavelength, and cause the display 430 to display the spectral image.

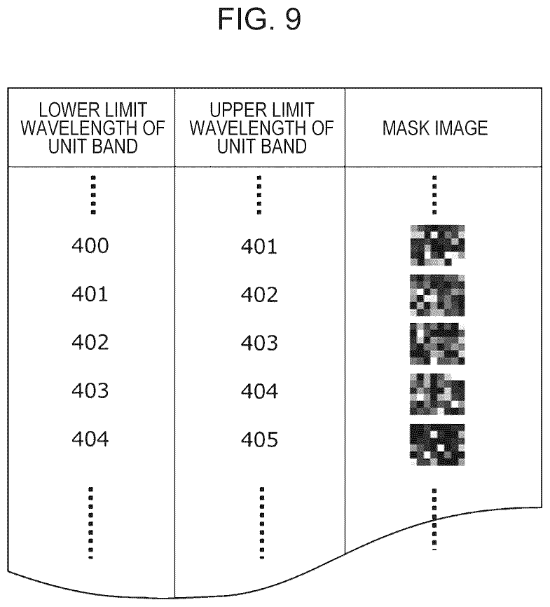

FIG. 9 illustrates an example of the mask data stored in the memory 210. The mask data in this example contains information about mask images for deriving the spatial distribution of the transmittance with respect to the respective unit bands included in the target wavelength range. The mask data in this example contains a mask image for each of many unit bands segmented for every nanometer. Each unit band is specified in accordance with a lower limit wavelength and an upper limit wavelength. Each mask image illustrated in FIG. 9 is acquired by the image sensor 160 capturing an image of the background having a color of the corresponding unit band via the filter array 110. The data of such a mask image is stored in advance for every unit band. The width of each unit band is not limited to 1 nm and may be set to any value. Each element of the aforementioned matrix H is determined based on the pixel values respectively corresponding to the pixels included in each mask image illustrated in FIG. 9. Each element of the matrix H may be determined by normalizing each pixel value in accordance with the maximum value of the number of bits set for the pixel values.

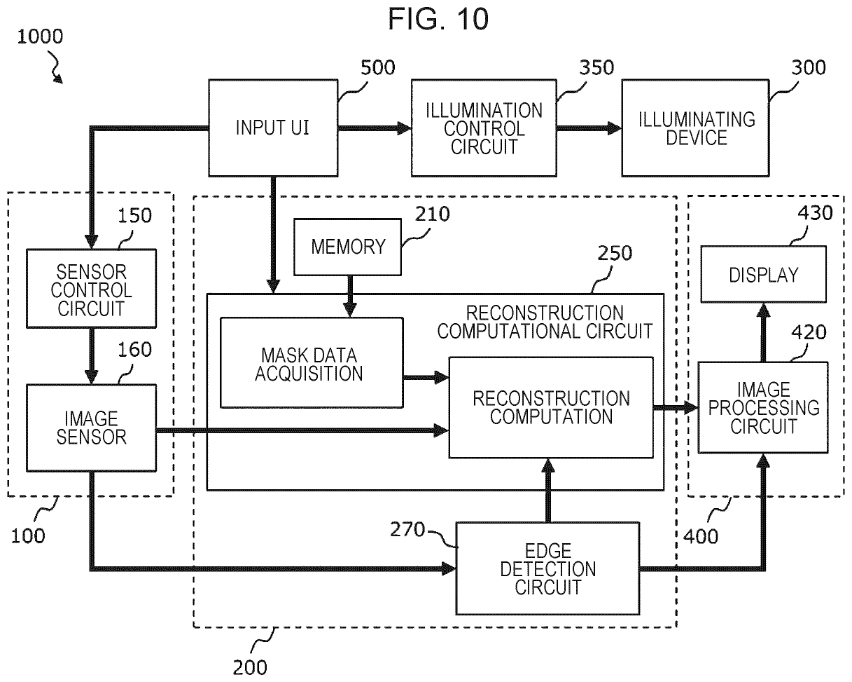

FIG. 10 is a block diagram illustrating another configuration example of the imaging system 1000. The processing device 200 in this example further includes an edge detection circuit 270. The edge detection circuit 270 generates an edge image that emphasizes the edges of the compressed image based on the compressed image output from the image sensor 160. The processing device 200 causes the display device 400 to display the generated edge image.

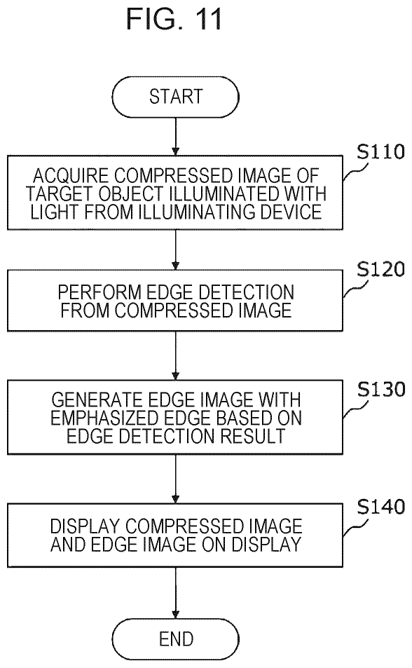

FIG. 11 is a flowchart illustrating an example of the operation of the processing device 200 according to this embodiment. In this example, in step S110, the processing device 200 acquires, from the imaging device 100, a compressed image of a target object illuminated with non-uniform light from the illuminating device 300. In step S120, the processing device 200 detects edges of the compressed image. The edge detection may be performed by, for example, using an edge detection algorithm using a filter, such as a Sobel filter, a Laplacian filter, or a Canny filter, on the compressed image. Alternatively, the edge detection from the compressed image may be performed by using a learned model preliminarily trained by machine learning, such as deep learning. In step S130, the processing device 200 generates an edge image that emphasizes the edges of the compressed image based on the edge detection result. In step S140, the processing device 200 causes the display 430 to display the compressed image and the edge image.

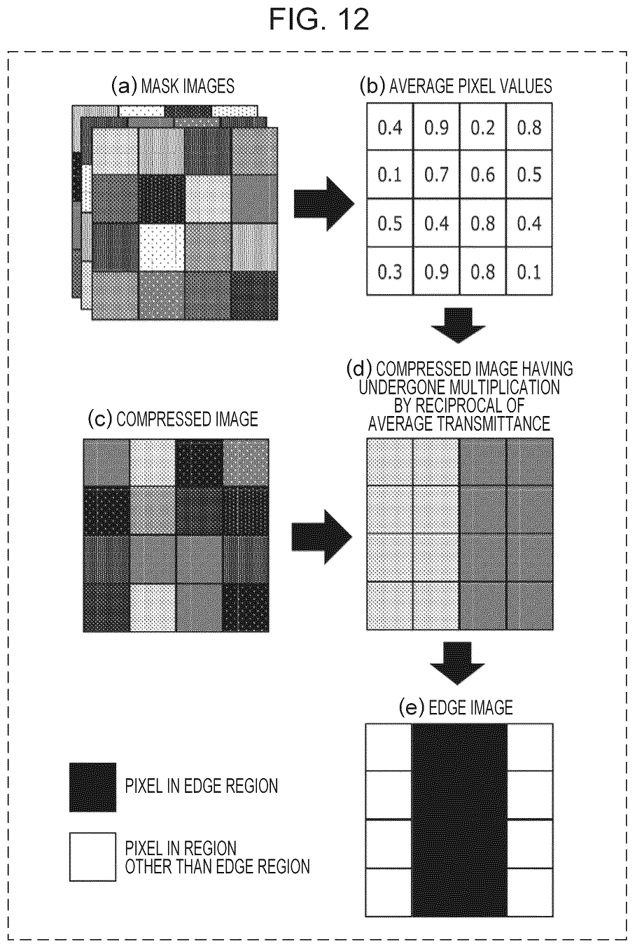

FIG. 12 illustrates an example of a method for generating an edge image. In this example, the processing device 200 generates an edge image based on mask data reflecting the spatial distribution of the transmission spectrum of the filter array 110 and also based on the compressed image. In detail, the processing device 200 generates an edge image on the basis of an image converted from the compressed image based on an average pixel value of each pixel of a mask image for each band included in the mask data. Part (a) of FIG. 12 schematically illustrates mask images. For simplification, 4×4 pixel regions of the mask images are schematically illustrated. Part (b) of FIG. 12 illustrates an example of average pixel values of respective pixels of each mask image. The average pixel value of each pixel corresponds to average transmittance (i.e., an average transmittance value for each band) of the region of the filter array 110 corresponding to the pixel. Part (c) of FIG. 12 schematically illustrates the compressed image output from the imaging device 100. Part (d) of FIG. 12 schematically illustrates an image obtained by multiplying the pixel value of each pixel of the compressed image by the reciprocal of the average pixel value (i.e., average transmittance) of the corresponding pixel in the mask image. The processing device 200 may perform the edge detection from the image obtained in this manner by weighting the compressed image based on the reciprocal of the average pixel value for each pixel of the mask image, and generate an edge image, as illustrated in part (c) of FIG. 12. This method can suppress an effect caused due to variations in the transmission spectra of the filter array 110 from region to region. Thus, the edges of the target object can be detected more accurately than in a method of directly detecting the edges from the compressed image.

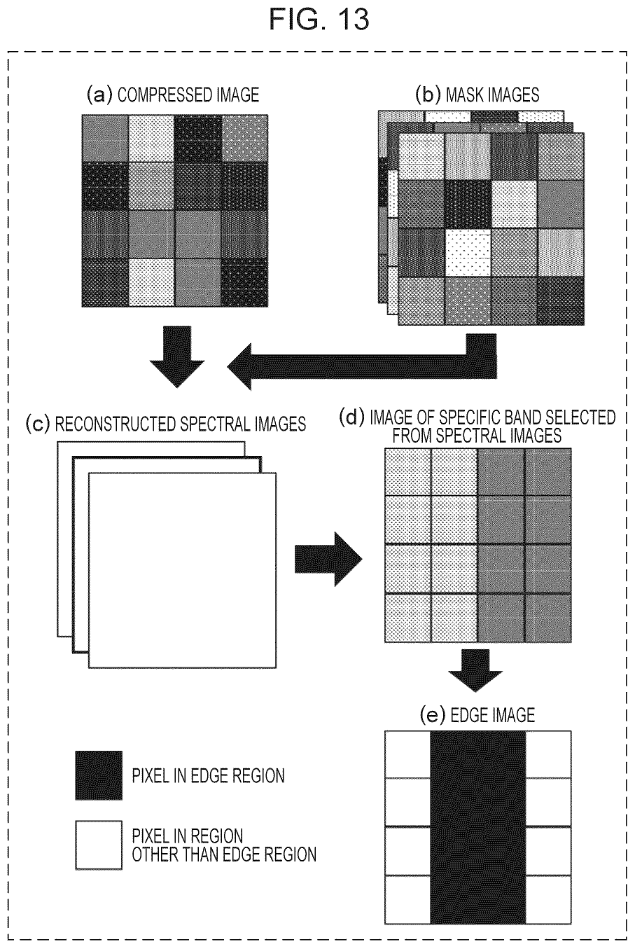

FIG. 13 illustrates another example of the method for generating an edge image. In this example, the processing device 200 generates an edge image from a spectral image reconstructed based on the compressed image and the mask image. As illustrated in parts (c) and (d) of FIG. 13, the processing device 200 selects one of reconstructed spectral images and generates an edge image based on the selected spectral image. For example, the processing device 200 may detect edges from reconstructed images of all the bands included in the spectral images and select one reconstructed image with the most detected edges. Alternatively, the processing device 200 may select, from the spectral images, a reconstructed image corresponding to the central band estimated to have the highest reconstruction accuracy.

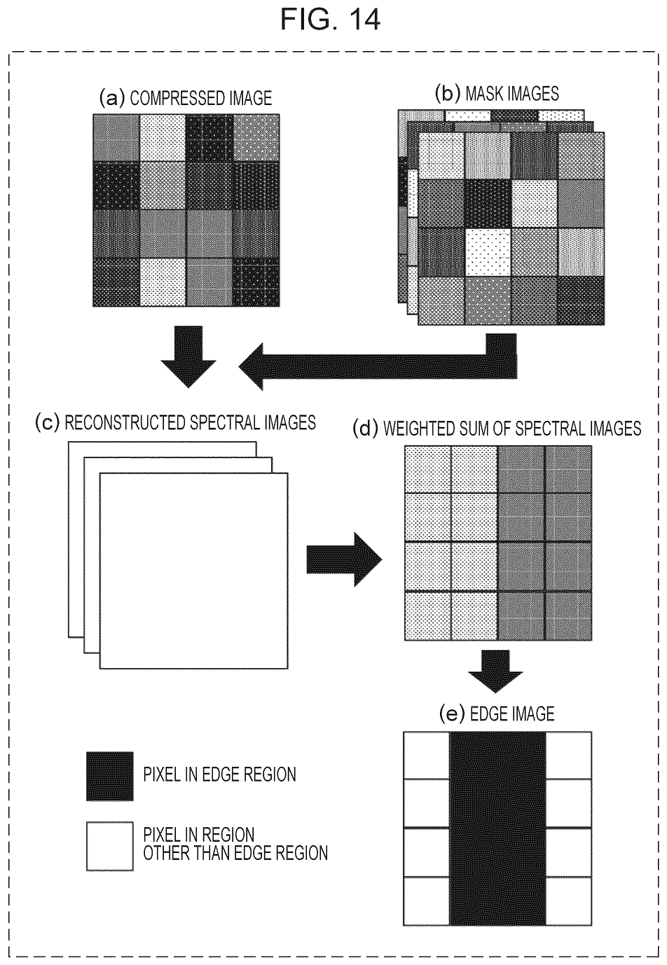

FIG. 14 illustrates yet another example of the method for generating an edge image. In this example, as illustrated in parts (c) and (d) of FIG. 14, the processing device 200 generates one image by performing a weighted summation of pixel values of respective pixels in reconstructed images of all the bands included in a reconstructed spectral image, and generates an edge image from the one image. The weighted summation may involve simply averaging the pixel value of each pixel (i.e., fixed weight) or may be performed by applying weighting based on human visual sensitivity, such as by increasing the weight of the band corresponding to the green color.

Accordingly, the processing device 200 may generate an edge image based on the mask data reflecting the spatial distribution of the transmission spectrum of the filter array 110 and at least one reconstructed image included in the multiple reconstructed images. Accordingly, the edges of the target object can be detected more accurately.

The following description relates to a display example of the compressed image and the edge image in step S140. As exemplified below, the processing device 200 may be configured to cause the display device 400 to display the compressed image and the edge image. Accordingly, the user can determine whether or not the edges in the compressed image are clear, and can change the spectrum of the illumination light to make the edges more clear, if the edges are unclear, by adjusting the illuminating device 300. The adjustment of the illuminating device 300 may be performed manually or may be performed automatically by the processing device 200.

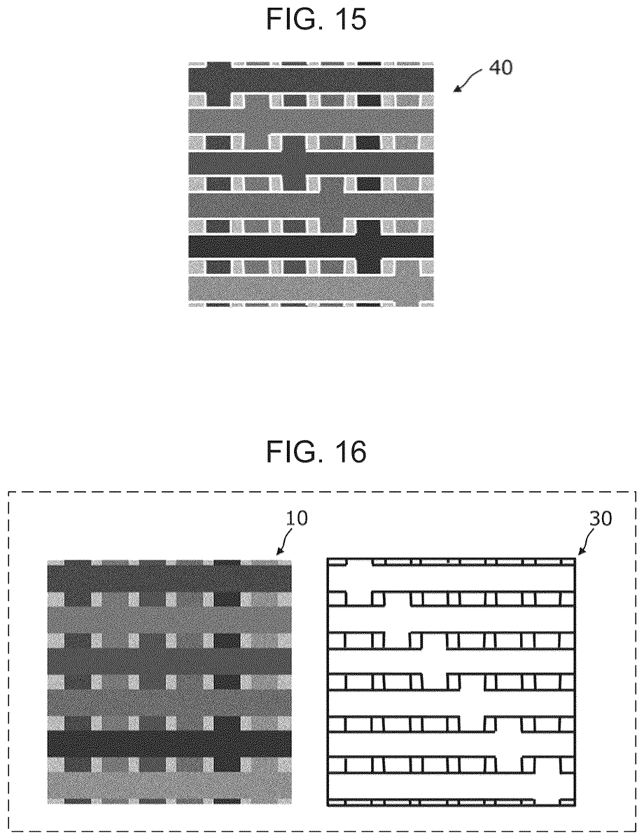

FIG. 15 illustrates an example where the compressed image and the edge image are displayed in a superimposed manner. As illustrated in FIG. 16, the processing device 200 may be configured to generate a superimposed image 40 by superimposing the compressed image and the edge image on each other, and output the superimposed image 40 to the display device 400. For example, the superimposed image 40 may be generated by superimposing the edge image, which is colored, onto the compressed image. For example, the edge image superimposed on the compressed image may be an image in which the pixels in an edge region are expressed with a color, such as black, white, red, or blue, distinguishable from that of the pixels in a region other than the edge region. The pixels near the edge region may similarly be colored. For example, the edges may be displayed with an increased width by performing image processing, such as closing or opening, on the pixels in the edge region.

FIG. 16 illustrates an example where the compressed image 10 and an edge image 30 are displayed within the same screen. As illustrated in FIG. 16, the processing device 200 may cause the display device 400 to display the compressed image 10 and the edge image 30 side-by-side. Although the compressed image 10 and the edge image 30 are displayed next to each other in the example in FIG. 16, the two may be displayed at positions located away from each other on the screen. The compressed image 10 and the edge image 30 may be displayed at the same timing or at different timings. Accordingly, the processing device 200 may be configured to cause the compressed image 10 and the edge image 30 to be displayed within the same screen. Similar to the example in FIG. 15, the edge image 30 is an image in which the pixels in an edge region and the pixels in a region other than the edge region are distinguishable by color. For example, the edge image 30 may be an image in which the pixels in the edge region are expressed with a color, such as black, white, red, or blue, distinguishable from that of the pixels in the region other than the edge region.

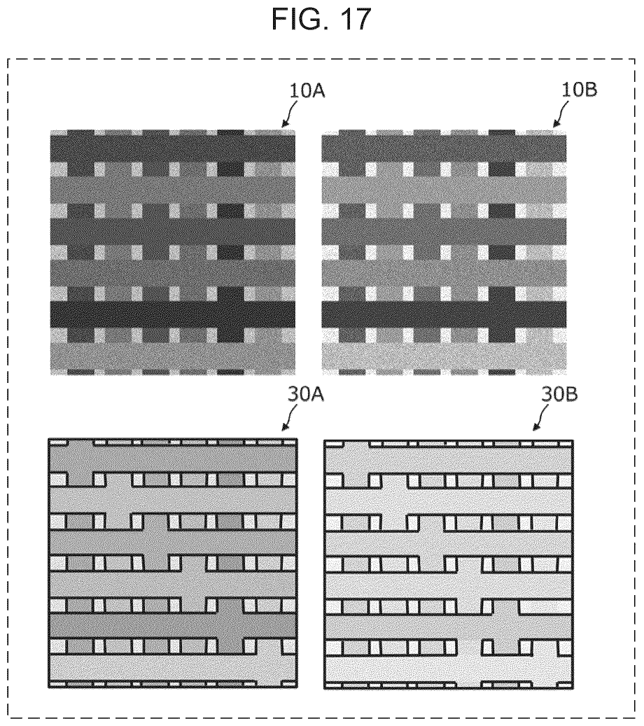

FIG. 17 illustrates another display example of the compressed image and the edge image. In this example, imaging is performed multiple times by using illumination light beams having different spectra. The processing device 200 causes the display device 400 to display compressed images 10A and 10B, acquired as a result of multiple imaging processes, and edge images 30A and 30B, generated based on the respective compressed images 10A and 10B, in a side-by-side arrangement. Although the edge images 30A and 30B illustrated in FIG. 17 are displayed using light and dark gradation reflecting the brightness values of the pixels of the compressed images 10A and 10B together with solid lines denoting the edges, such light and dark gradation does not have to be displayed. The processing device 200 may display the compressed images 10A and 10B and the edge images 30A and 30B at positions located away from each other within the same screen. The compressed images 10A and 10B and the edge images 30A and 30B may be displayed at the same timing or at different timings.

In the example in FIG. 17, the illuminating device 300 is configured to output first illumination light and second illumination light having a spectral shape different from that of the first illumination light. The term “spectral shape” refers to the shape of a spectrum (i.e., wavelength distribution of light intensity) in which the intensity of each wavelength band is normalized based on the intensity of a certain reference wavelength band. On the other hand, the intensity of each wavelength band in a non-normalized spectrum is referred to as “spectral intensity”. It is interpreted that the spectral shape is the same between a certain spectrum and a spectrum in which the intensity of each wavelength band in the certain spectrum has been uniformly multiplied by a constant. The imaging device 100 is configured to generate the first compressed image 10A by receiving reflected light originating from the first illumination light and coming from the target object, and to generate the second compressed image 10B by receiving reflected light originating from the second illumination light and coming from the target object. The processing device 200 is configured to generate the first edge image 30A based on the first compressed image 10A and to generate the second edge image 30B based on the second compressed image 10B.

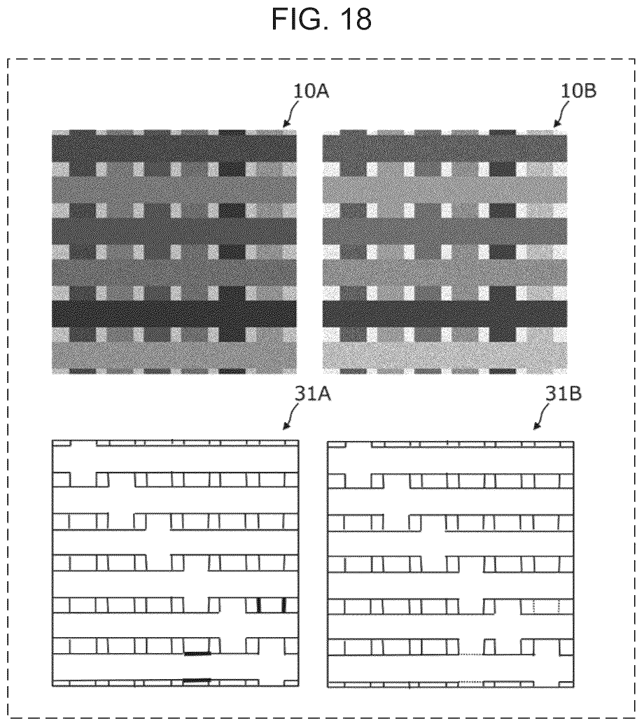

FIG. 18 illustrates yet another display example of the compressed image and the edge image. In this example, the processing device 200 causes the display device 400 to display the compressed images 10A and 10B, acquired as a result of multiple imaging processes using illumination light beams having different spectra, and difference images 31A and 31B, indicating a difference between edge images generated based on the respective compressed images 10A and 10B, in a side-by-side arrangement. The processing device 200 can generate the difference images 31A and 31B by calculating, for each pixel, differences between the pixel values of the pixels included in the edge image 30A illustrated in FIG. 17 and the pixel values of the pixels included in the edge image 30B and having a one-to-one correspondence relationship with the pixels included in the edge image 30A. In the difference images 31A and 31B in the example in FIG. 18, the edges are displayed with narrow lines, whereas edge regions with differences are displayed with bold or dotted lines. Each difference image may be an image in which an edge region with a difference and an edge region without a difference are distinguishable by color. For example, the pixels in an edge region with a difference may be displayed with a color, such as black, white, red, or blue, different from that of the pixels in an edge region without a difference. The pixels near the edge region with the difference may similarly be colored. For example, the edges may be displayed with an increased width by performing image processing, such as dilation or erosion, on the pixels in the edge region with the difference. The processing device 200 may cause the compressed images 10A and 10B and the difference images 31A and 31B to be displayed at positions located away from each other within the same screen. The compressed images 10A and 10B and the difference images 31A and 31B may be displayed at the same timing or at different timings.

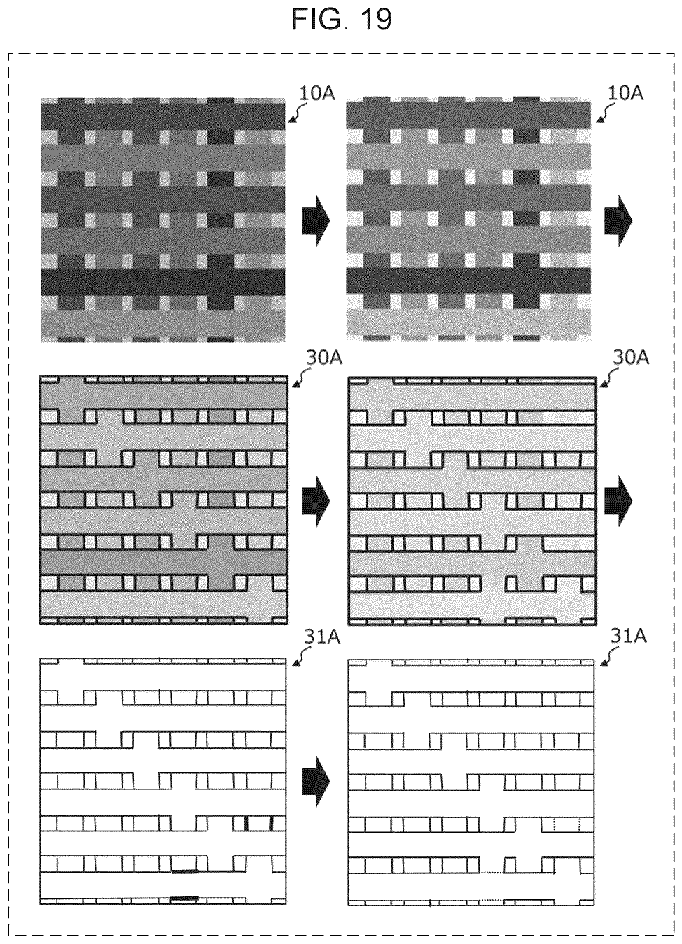

FIG. 19 illustrates yet another display example of the compressed image and the edge image. In this example, the processing device 200 causes the display device 400 to display the compressed images 10A and 10B, acquired as a result of multiple imaging processes using illumination light beams having different spectra, the edge images 30A and 30B, generated based on the compressed images 10A and 10B, and the difference images 31A and 31B, indicating differences between the edge images, in a sequentially switching fashion. Without being limited to the example illustrated in FIG. 19, the processing device 200 may cause at least two images selected from the compressed images, superimposed images, edge images, and difference images to be displayed in a sequentially switching fashion. Moreover, at least two sets of the compressed images, superimposed images, edge images, and difference images may be displayed on the same screen (e.g., simultaneously), and the sets of images to be displayed within the same screen may be switched. For example, sets of compressed images and edge images, sets of compressed images and superimposed images, sets of compressed images, superimposed images, and difference images, or sets of compressed images and difference images may be displayed in a switching fashion. By performing such display, the user can readily determine whether or not the edges in a compressed image are clear.

In each of the examples in FIG. 15 to FIG. 19, the processing device 200 may cause the display device 400 to also display at least one reconstructed image included in a hyperspectral image (i.e., reconstructed images) reconstructed based on a compressed image.

The following description relates to an example where the processing device 200 automatically adjusts the spectrum of illumination light from the illuminating device 300.

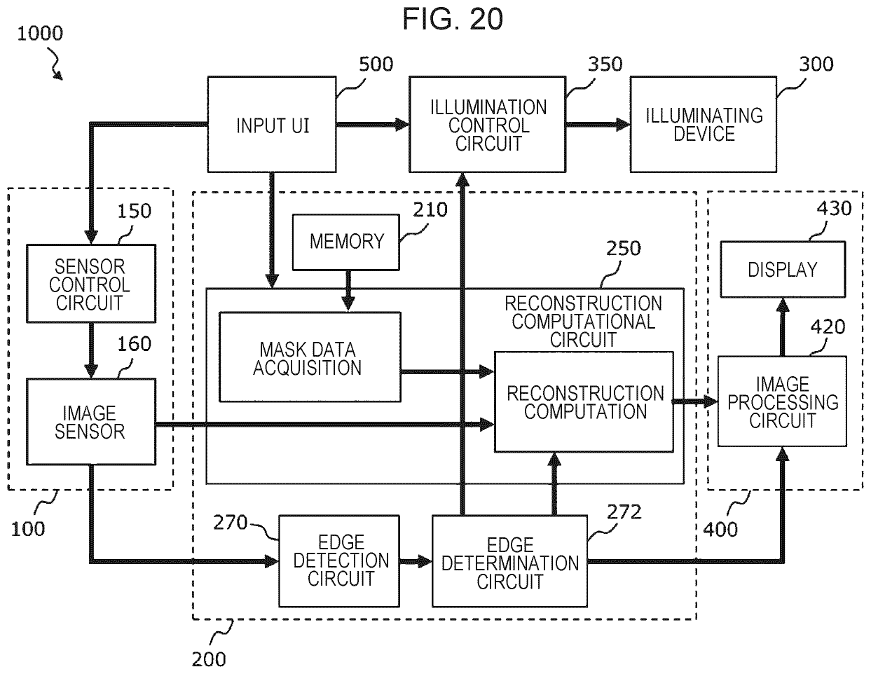

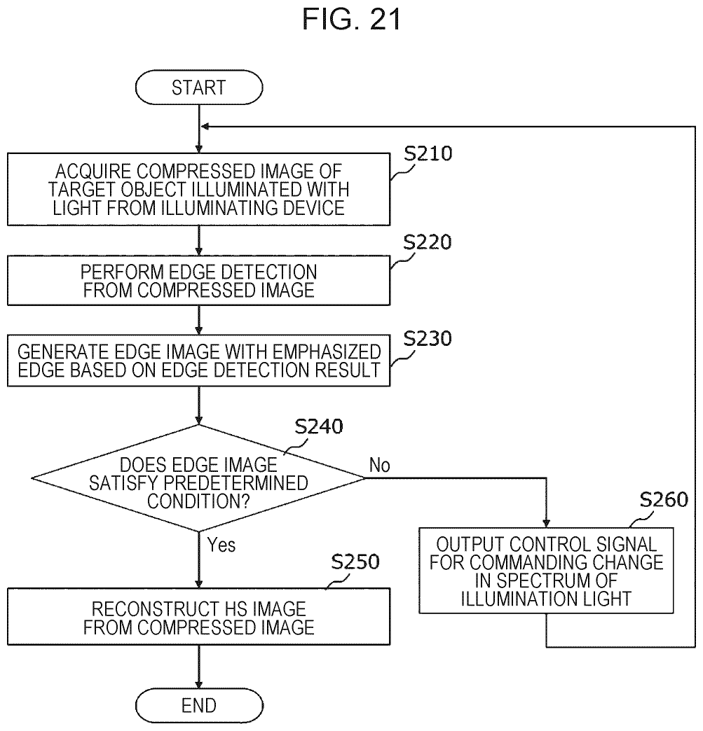

FIG. 20 is a block diagram illustrating a configuration example of the imaging system 1000 in which the processing device 200 automatically adjusts the spectrum of illumination light from the illuminating device 300 based on a compressed image. The imaging system 1000 illustrated in FIG. 20 includes an edge determination circuit 272 in addition to the components illustrated in FIG. 10. The edge determination circuit 272 determines whether or not the spectrum of the illumination light has to be changed based on an edge image generated by the edge detection circuit 270. For example, the edge determination circuit 272 determines whether or not the spectrum of the illumination light has to be changed based on the amount of edges included in the edge image. If the edge determination circuit 272 determines that the spectrum of the illumination light has to be changed, the edge determination circuit 272 causes the illumination control circuit 350 to send a command for changing the spectrum of the illumination light. In response to the command, the illumination control circuit 350 can change the spectrum of the illumination light by switching light sources in the illuminating device 300 or by switching optical filters that modulate the light output from the light source. The functions of the edge detection circuit 270 and the edge determination circuit 272 may be implemented by a single processing circuit.

The edge determination circuit 272 determines whether or not the edge image satisfies a predetermined condition. If the condition is not satisfied, the edge determination circuit 272 commands the illumination control circuit 350 to change the spectrum of the illumination light. The condition may be such that the maximum length of a seamless continuous edge among the edges detected from the compressed image is greater than or equal to a fixed value. Alternatively, the condition may be such that the similarity to a reference edge image generated from a preliminarily-prepared reference image of the target object is greater than or equal to a fixed value. The reference image may be a preliminarily-photographed image of a target object of the same type as the target object to be tested or may be computer-aided design (CAD) data of the target object.

The similarity between the edge image and the reference edge image may be calculated based on, for example, the following method. First, the brightness of the edge image is defined as E(u, v), and the brightness of the reference edge image is defined as R(u, v). In this case, (u, v) denotes the coordinates of a pixel, the brightness of pixels corresponding to an edge is defined as 1, and the brightness of pixels not corresponding to an edge is defined as 0. Similarity S may be calculated based on the following expression.

$$s = \frac{2 \sum E ( u , v ) R ( u , v )}{\sum E ( u , v ) + \sum R ( u , v )}$$

The similarity S has a value of 1 when the edge image and the reference edge image completely match, and has a value of 0 when the images completely differ from each other.

FIG. 21 is a flowchart illustrating an example of the operation of the processing device 200. In this example, in step S210, the processing device 200 acquires, from the imaging device 100, a compressed image of a target object illuminated with light from the illuminating device 300. In step S220, the processing device 200 detects edges of the compressed image. The edge detection method is as described above. In step S230, the processing device 200 generates an edge image that emphasizes the edges of the compressed image based on the edge detection result. In step S240, the processing device 200 determines whether or not the edge image satisfies a predetermined condition. If the condition is satisfied, the processing device 200 reconstructs a hyperspectral (HS) image based on the compressed image in step S250. If the condition is not satisfied, the processing device 200 outputs a control signal for commanding a change in the spectrum of the illumination light to the illumination control circuit 350 in step S260. Upon step S260, the process returns to step S210. Steps S210, S220, S230, S240, and S260 are repeated until the predetermined condition is satisfied in step S240.

As mentioned above, the predetermined condition in step S240 may be such that, for example, the maximum length of a seamless continuous edge in the edge image is greater than or equal to the fixed value. Alternatively, the condition may be such that the similarity to the reference edge image generated from the preliminarily-prepared reference image of the target object is greater than or equal to the fixed value.

The changing of the spectrum of the illumination light in step S260 may be implemented based on, for example, any of the following methods (1) to (4).

(1) Switch between preliminarily-prepared light sources having different output light spectra (i.e., use one light source).

(2) Change the output power of each of the preliminarily-prepared light sources having different output light spectra (i.e., use a combination of light sources).

(3) Change the optical filter to be inserted into the optical path of the output light from the light source.

(4) Combine the switching of light sources and the changing of the optical filter.

If the above method (3) or (4) is to be employed, the imaging system 1000 includes an actuator that inserts a specific optical filter into the optical path, and the illumination control circuit 350 drives the actuator in response to a control signal from the processing device 200, so that the spectrum of the illumination light can be changed.

Accordingly, in the example illustrated in FIG. 21, based on the compressed image acquired by the image sensor 160, the processing device 200 determines whether or not it is necessary to switch from a mode for causing the illuminating device 300 to output illumination light having a certain spectrum to a mode for causing the illuminating device 300 to output illumination light having another spectrum. For example, based on the amount of edges included in the compressed image, the processing device 200 determines whether or not the output mode of the illumination light has to be switched. Alternatively, the processing device 200 may acquire a reference image, emphasizing the edges of the target object and generated based on a method different from imaging using the imaging device 100, and determine whether or not the output mode of the illumination light has to be switched on the basis of a comparison between the edge image, generated based on the compressed image, and the reference image. By performing such an operation, a compressed image with clear edges can be acquired, thereby enhancing the reconstruction accuracy for a hyperspectral image based on the compressed image.

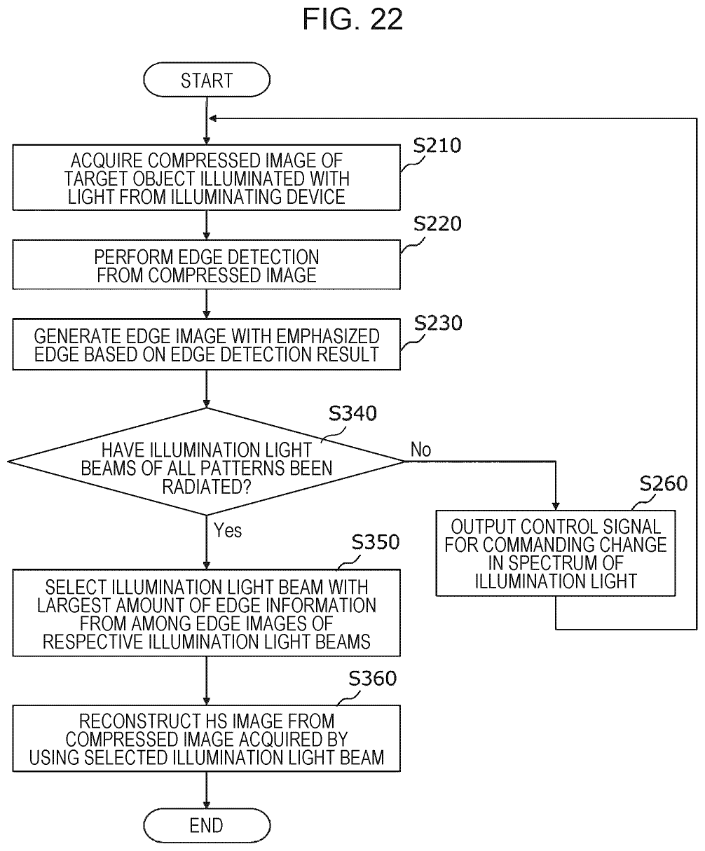

FIG. 22 is a flowchart illustrating another example of the operation of the processing device 200. Steps S210, S220, S230, and S260 in this example are identical to the corresponding steps illustrated in FIG. 21. In the example in FIG. 22, after step S230, the processing device 200 determines in step S340 whether illumination light beams of all patterns have been radiated. If the determination result indicates Yes, the process proceeds to step S350. If the determination result indicates No, the process proceeds to step S260. Specifically, steps S210, S220, S230, S340, and S260 are repeated until it is determined in step S340 that illumination light beams of all patterns have been radiated. The number of patterns of the illumination light beams is greater than or equal to two, may be greater than or equal to 10 in a certain example, and may be greater than or equal to 20 in another example. When imaging using the illumination light beams of all patterns is completed, the processing device 200 selects the illumination light beam with the largest amount of edge information from among edge images generated with respect to the respective illumination light beams in step S350. In step S360, the processing device 200 reconstructs a hyperspectral image from a compressed image acquired by using the selected illumination light beam.

The selection of the illumination light beam in step S350 may be performed based on, for example, any of the following methods (a) to (c).
(a) Select an illumination light beam corresponding to an edge image with the largest number of pixels detected as edges.
(b) Select an illumination light beam corresponding to an edge image that includes an edge with the maximum length when pixels detected as edges are joined.
(c) Select an illumination light beam corresponding to an edge image with the most similarity to an edge image generated based on a preliminarily-prepared reference image of the target object.

Accordingly, in the example illustrated in FIG. 22, based on compressed images generated by sequentially performing imaging using illumination light beams with different spectra, the processing device 200 determines whether to generate a hyperspectral image, that is, reconstructed images, based on any of the compressed images. For example, based on a comparison with the amount of edges included in edge images generated from compressed images, the processing device 200 determines whether to generate reconstructed images based on any of the compressed images. By performing such a process, reconstructed images are generated based on a compressed image with clear edges, so that the reconstruction accuracy can be enhanced.

In the above embodiment, the processing device 200 generates reconstructed images based on a compressed image acquired by imaging using illumination light with a non-uniform spectrum in the target wavelength range. Without being limited to such an operation, the processing device 200 may generate reconstructed images by also using illumination light with a uniform spectrum. In that case, the imaging using the illumination light with the non-uniform spectrum may be performed for determining an optimal reconstruction parameter. In such a configuration, the illuminating device 300 may be configured to output the first illumination light and the second illumination light having different spectral shapes from each other, as well as third illumination light with a uniform spectral intensity in the target wavelength range. The expression “uniform spectral intensity in the target wavelength range” does not imply that the light intensity is uniform in a precise sense, but that the light intensity in the target wavelength range is within a range of +20% or less of an average value in the target wavelength range. Illumination light with a uniform spectral intensity may also be expressed as “illumination light with a substantially uniform spectrum”. The imaging device 100 may be configured to generate a first compressed image by imaging using the first illumination light, generate a second compressed image by imaging using the second illumination light, and generate a third compressed image by imaging using the third illumination light. The processing device 200 may be configured to generate reconstructed images based on the first compressed image, the second compressed image, and the third compressed image.

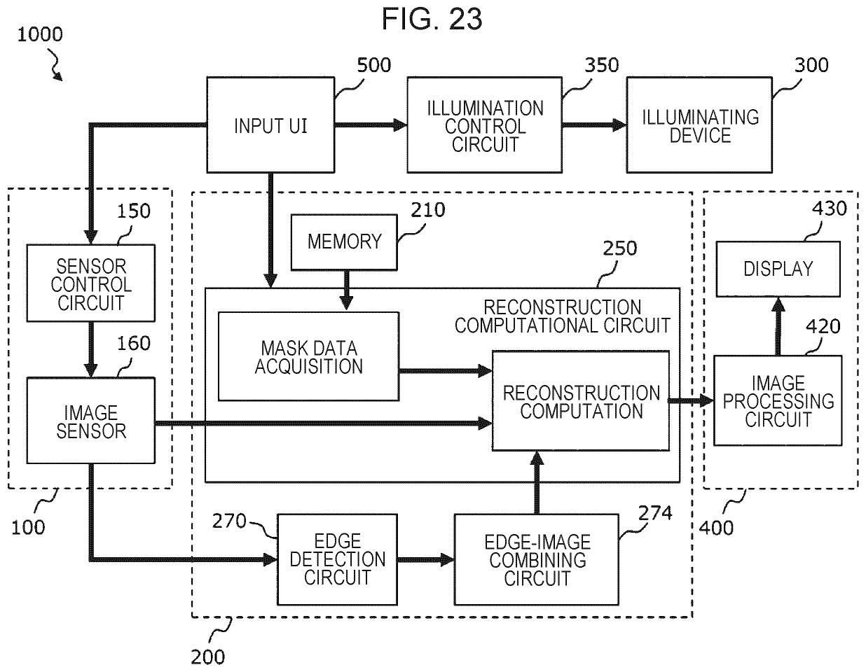

FIG. 23 is a block diagram illustrating a configuration example of the imaging system 1000 that generates a reconstructed image by also using illumination light with a uniform spectrum. In this example, the processing device 200 includes an edge-image combining circuit 274 in place of the edge determination circuit 272 illustrated in FIG. 20. The edge-image combining circuit 274 generates a single combined edge image from edge images based on compressed images captured by using multiple types of illumination light beams with non-uniform spectra. For example, the edge-image combining circuit 274 may be configured to generate a combined edge image by performing an OR computation between edge images. Such a combined edge image includes all edges detected in at least one edge image. Alternatively, the edge-image combining circuit 274 may generate a combined edge image by combining, as edge pixels, pixels detected as edges in edge images, the number of which is greater than or equal to a threshold value, among multiple edge images.

In the example in FIG. 23, the illuminating device 300 is configured to be capable of outputting illumination light with a substantially uniform spectrum in the target wavelength range. The reconstruction computational circuit 250 may be configured to generate reconstructed images based on a compressed image, acquired by capturing an image of the target object irradiated with the illumination light with the substantially uniform spectrum, and the combined edge image. For example, the reconstruction computational circuit 250 may determine a reconstruction parameter for generating reconstructed images based on the combined edge image, and generate reconstructed images based on the reconstruction parameter and the compressed image. The reconstruction parameter may be, for example, the weighting factor t in the second term, that is, the regularization term, within the parentheses at the right-hand side of Expression (2) indicated above. The regularization term may be, for example, total variation (TV). For example, the reconstruction computational circuit 250 may perform the reconstruction computation by reducing the weighting factor t of the pixels corresponding to the edges in the combined edge image relative to the values of other pixels, thereby enhancing the reconstruction accuracy for the hyperspectral image.

The target object has various edges, and the spectrum of the illumination light suitable for detection varies depending on the edge. For example, if a light blue region and a yellow region are in contact with each other in the target object, edge detection tends to be difficult with irradiation using white or green illumination light, but tends to be easy with irradiation using red or blue illumination light. In contrast, if a white region and a green region are in contact with each other, edge detection tends to be easy with irradiation using white or green illumination light, but tends to be difficult with irradiation using red or blue illumination light.

In this embodiment, edges are detected by sequentially outputting multiple types of illumination light beams with different spectra, and edge images are integrated, thereby facilitating the detection of edges in the overall image. Furthermore, since illumination light with a uniform spectrum is advantageous when performing image reconstruction, the processing device 200 switches between illumination light for edge detection and illumination light for image reconstruction, thereby enhancing the reconstruction accuracy.

As in this embodiment, when the reconstruction of a spectral image is implemented by a computation that minimizes the regularization term, such as total variation indicating the smoothness of an image, the reconstruction accuracy decreases in edge regions with different wavelength characteristics in the target object. This brings the spectra of two neighboring regions closer to each other to reduce the regularization term. In view of this, in this embodiment, the processing device 200 preliminarily determines an edge and reduces the weighting factor t in the region of the edge. Accordingly, a situation where the spectra of two neighboring regions are brought excessively closer to each other can be suppressed, thereby enhancing the reconstruction accuracy.

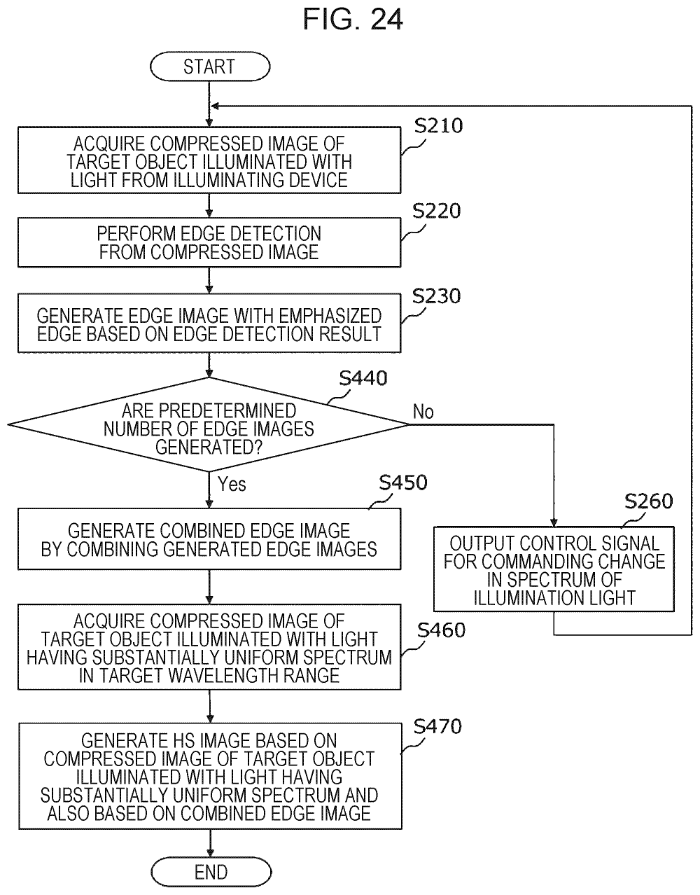

FIG. 24 is a flowchart illustrating an example of the operation of the processing device 200 according to this embodiment. Steps S210, S220, S230, and S260 in this example are identical to the corresponding steps illustrated in FIG. 21 and FIG. 22. In this embodiment, after step S230, the processing device 200 determines in step S440 whether or not a predetermined number of edge images are generated. The predetermined number may be set to, for example, a number equal to the number of types of spectra outputtable by the illuminating device 300, or a number smaller than or equal to the number of types of spectra outputtable by the illuminating device 300 but greater than or equal to two. If the determination result indicates Yes, the process proceeds to step S450. If the determination result indicates No, the process proceeds to step S260. Steps S210, S220, S230, S440, and S260 are repeated until the determination result in step S440 indicates Yes. When the predetermined number of edge images are generated, the processing device 200 combines the generated edge images based on the aforementioned method to generate a combined edge image in step S450. Then, the processing device 200 acquires a compressed image of the target object illuminated with light having a substantially uniform spectrum in the target wavelength range. Based on the compressed image of the target object illuminated with the light having the substantially uniform spectrum and the combined edge image, the processing device 200 generates a hyperspectral image (i.e., reconstructed images) in step S470. As mentioned above, the hyperspectral image is generated by, for example, reducing the weighting factor t in the total variation of the pixels corresponding to the edges in the combined edge image relative to the values of other pixels.

As a result of the above process, an edge region is detected with high accuracy from compressed images acquired by imaging using illumination light beams with non-uniform spectra, and a high-quality hyperspectral image can be generated by using the detection result.

In the above embodiment, an edge detection process based on at least one compressed image and a reconstructed-image generating process are executed by a single processing device 200. The above embodiment is not limited to this configuration, such that a processing device for detecting edges and a processing device for generating reconstructed images may be separated from each other. For example, the imaging system 1000 may include a processing device for detecting edges and does not have to include a processing device for generating reconstructed images. In that case, the reconstructed-image generating process may be executed by an external device, such as a cloud server, connected to the imaging system 1000 via a network. The imaging system 1000 may include a communication device that communicates with such an external device.

The present disclosure also includes a system that generates a compressed image and an edge image by simulation based on preliminarily-prepared data without having an actually-prepared illuminating device 300 and target object, and that determines an optimal spectrum of illumination light in accordance with an assumed target object. An example of such a system will be described below.

FIG. 25 is a block diagram illustrating a configuration example of a system 2000 that determines an optimal spectrum of illumination light in accordance with an assumed target object. The system 2000 includes the processing device 200, the display device 400, and the input UI 500. The processing device 200 includes the memory 210 and a processing circuit 280.

The input UI 500 is an interface used for inputting first data related to a spectral reflectance characteristic of the assumed target object. The first data has, for example, a spectral reflectance value for each region or pixel of the target object. The first data may be CAD data having a spectral reflectance value for each region of the target object.

The memory 210 stores second data related to a spectrum of illumination light radiated onto the target object, and third data related to a spectral sensitivity characteristic of each pixel of the imaging device 100 that captures an image of the target object. The second data may be, for example, data indicating the spectra of illumination light beams outputtable by the aforementioned illuminating device 300. The third data may be, for example, the aforementioned mask data reflecting the spatial distribution of the spectral transmittance of the filter array 110. The second data and the third data may be input from the input UI 500.

The processing circuit 280 acquires the first data, the second data, and the third data, and, based on the acquired data, generates an estimated image estimated to be generated when the imaging device 100 captures an image of the target object irradiated with illumination light. This estimated image corresponds to a virtual compressed image. The processing circuit 280 generates an edge image on the basis of the estimated image based on the aforementioned method, and causes the display device 400 to display the edge image.

Assuming that the positional coordinates of each pixel of the estimated image corresponding to a position on the surface of the target object are defined as (x, y) and the wavelength is defined as λ, each of the first data, the second data, and the third data may be data (e.g., table) indicating a function dependent on the positional coordinates (x, y) and the wavelength λ. It is assumed that the first data indicates spectral reflectance p (x, y, λ) of the target object, the second data indicates intensity I (x, y, λ) of the illumination light, and the third data indicates spectral sensitivity s (x, y, λ) of the imaging device 100. The third data corresponds to the aforementioned mask data. ρ, I, and s are all normalized within the range of 0 to 1. A brightness value L (x, y) at the coordinates (x, y) of the estimated image can be determined by a computation involving multiplying Σρ(x, y, λ) I (x, y, λ) s (x, y, λ) by a maximum pixel value (e.g., 255 or 1023). Instead of being multiplied by the maximum pixel value, Σρ(x, y, λ) I(x, y, π) s (x, y, λ) may be set as the brightness value L (x, y). In this case, Σ denotes a total sum (ideally, an integral) with respect to the wavelength λ. By performing the relevant computation, the processing circuit 280 can calculate the brightness value L of each pixel of the estimated image, that is, the virtual compressed image.

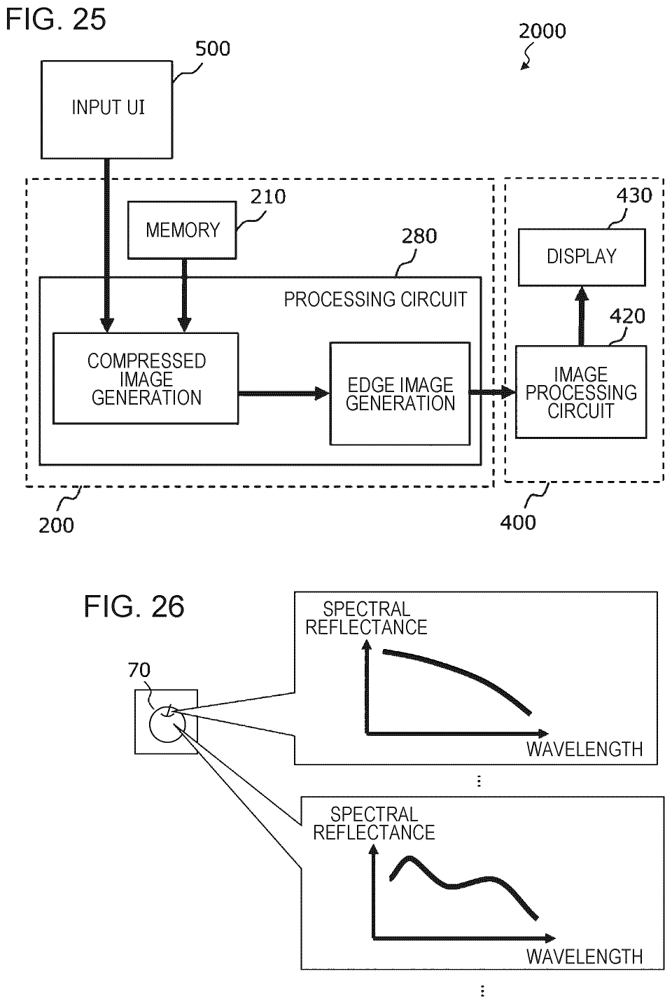

FIG. 26 illustrates an example of the spectral reflectance of the target object 70. In FIG. 26, the spectral reflectance at each of two locations on the surface of the target object 70 is illustrated. As illustrated in FIG. 26, the spectral reflectance varies depending on the location on the target object 70. Therefore, the first data indicating the spatial distribution of the spectral reflectance may be data having reflectance values equal in number to the wavelengths at each pixel. Alternatively, the first data may be data having reflectance values equal in number to the wavelengths at each voxel in CAD data.

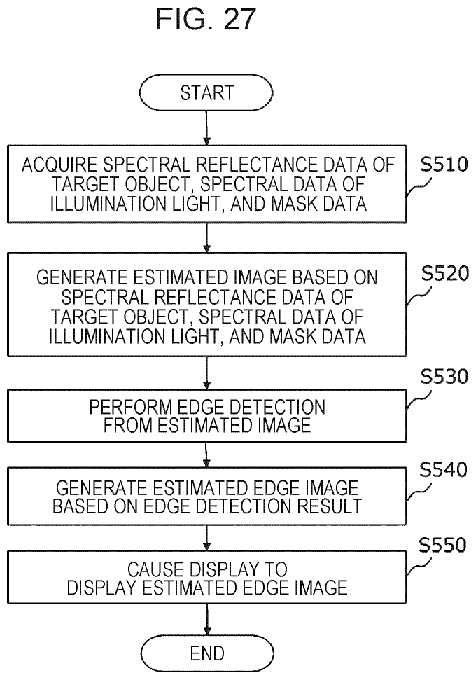

FIG. 27 is a flowchart illustrating an example of a process executed by the processing circuit 280. In this example, in step S510, the processing circuit 280 acquires spectral reflectance data of the target object (first data), spectral data of illumination light (second data), and mask data (third data) from the input UI 500 or the memory 210. In step S520, the processing circuit 280 generates an estimated image based on the spectral reflectance data of the target object, the spectral data of the illumination light, and the mask data in accordance with the above-described method. In step S530, the processing circuit 280 performs edge detection from the estimated image. The edge detection process may be similar to the process in step S120 illustrated in FIG. 11. In step S540, the processing circuit 280 generates an estimated edge image based on the edge detection result. The estimated-edge-image generating process may be similar to the process in step S130 illustrated in FIG. 11. In step S550, the processing circuit 280 causes the display 430 to display the estimated edge image.

With the above-described operation, the user can determine whether or not the spectrum of the illumination light is suitable for generating a spectral image of the target object based on the displayed estimated edge image. If the spectrum of the illumination light is not appropriate, the user may operate the input UI 500 to select another spectrum of illumination light and cause the processing circuit 280 to execute the operation illustrated in FIG. 27 again. By repeating this operation, an optimal spectrum of illumination light can be determined.

The processing circuit 280 may perform a process for changing the spectral data of the illumination light until the estimated edge image satisfies a predetermined condition. Specifically, the generation of the estimated image and the generation of the estimated edge image may be repeated while changing the spectral data of the illumination light. The predetermined condition is similar to the condition in step S240 illustrated in FIG. 21. In that case, the memory 210 preliminarily has stored therein spectral data of multiple types of illumination light.

Similar to the example illustrated in FIG. 22, the processing circuit 280 may generate multiple estimated images based on the spectral data of the multiple illumination light beams and determine the illumination light beam emphasizing the edges the most as an optimal illumination light beam based on a comparison between the multiple estimated images.

The processing device 200 may cause the display 430 to display information indicating the optimal illumination light beam in place of an edge image or in addition to an edge image. With such information displayed, the user can select an optimal illumination light beam.

### Appendix

The present disclosure is not limited to the above embodiment. The scope of the present disclosure also encompasses each embodiment to which any of various modifications conceivable by a skilled person is applied, each modification example to which any of various modifications conceivable by a skilled person is applied, an embodiment established by combining components in different embodiments, an embodiment established by combining components in different modification examples, and an embodiment established by combining a component in any embodiment with a component in any modification example, so long as they do not depart from the scope of the present disclosure.

The following technologies are disclosed in accordance with the description of the above embodiment.

### Technique 1

An imaging system comprising:
an illuminator that outputs illumination light to be radiated onto a target object;
an imager that receives reflected light originating from the illumination light and coming from the target object and generates a compressed image in which image information of wavelength bands included in a target wavelength range is compressed as one piece of image information; and
a processor that generates reconstructed images based on the compressed image, each reconstructed image corresponding to a different one of the wavelength bands,
wherein the wavelength bands include a first wavelength band and a second wavelength band, and
wherein a light intensity in the first wavelength band included in the illumination light and a light intensity in the second wavelength band included in the illumination light are different from each other.

### Technique 2

The imaging system according to technique 1, wherein an intensity of the illumination light increases or decreases monotonously in accordance with an increase in wavelength in the target wavelength range.

### Technique 3

The imaging system according to technique 1 or 2, wherein the processor further generates an edge image based on the compressed image, the edge image emphasizing an edge of the compressed image.

### Technique 4

The imaging system according to technique 3, wherein the processor causes a display to display the edge image and the compressed image.

### Technique 5

The imaging system according to technique 3 or 4,
wherein the imager includes an optical element and an image sensor, the optical element including regions with different transmission spectra from each other, the image sensor generating the compressed image by receiving light transmitted through the optical element, and
wherein the processor generates the edge image based on mask data and the compressed image, the mask data reflecting a spatial distribution of the transmission spectra of the optical element.

### Technique 6

The imaging system according to technique 3 or 4,
wherein the imager includes an optical element and an image sensor, the optical element including regions with different transmission spectra from each other, the image sensor generating the compressed image by receiving light transmitted through the optical element, and
wherein the processor generates the edge image based on mask data and at least one reconstructed image included in the reconstructed images, the mask data reflecting a spatial distribution of the transmission spectra of the optical element.

### Technique 7

The imaging system according to technique 3 or 4, wherein the processor generates a superimposed image by superimposing the compressed image and the edge image on each other and outputs the superimposed image.

### Technique 8

The imaging system according to technique 3 or 4,
wherein the illuminator outputs the illumination light as first illumination light and further outputs second illumination light having a different spectral shape from the first illumination light,
wherein the imager generates the compressed image as a first compressed image, and further receives reflected light originating from the second illumination light and coming from the target object to generate a second compressed image in which image information of the wavelength bands is compressed as one piece of image information,
wherein the processor generates the edge image as a first edge image, and
wherein the processor further generates a second edge image based on the second compressed image, and generates and outputs a difference image indicating a difference between the first edge image and the second edge image.

### Technique 9

The imaging system according to technique 1 or 2,
wherein the illuminator outputs the illumination light as first illumination light and further outputs second illumination light having a different spectral shape from the first illumination light,
wherein the imager generates the compressed image as a first compressed image, and further receives reflected light originating from the second illumination light and coming from the target object to generate a second compressed image in which image information of the wavelength bands is compressed as one piece of image information, and
wherein the processor determines whether or not switching from a mode for outputting the first illumination light from the illuminator to a mode for outputting the second illumination light from the illuminator is necessary based on the first compressed image.

### Technique 10

The imaging system according to technique 9,
wherein the processor generates a first edge image based on the first compressed image, the first edge image emphasizing an edge of the first compressed image, and
wherein the processor determines whether or not the switching from the mode for outputting the first illumination light from the illuminator to the mode for outputting the second illumination light from the illuminator is necessary based on an amount of the edge included in the first edge image.

### Technique 11

The imaging system according to technique 10,
wherein the processor acquires a reference image generated by a method different from imaging using the imager, the reference image emphasizing an edge of the target object, and
wherein the processor determines whether or not the switching from the mode for outputting the first illumination light from the illuminator to the mode for outputting the second illumination light from the illuminator is necessary based on a comparison between the first edge image and the reference image.

### Technique 12

The imaging system according to technique 1 or 2,
wherein the illuminator outputs the illumination light as first illumination light and further outputs second illumination light having a different spectral shape from the first illumination light,
wherein the imager generates the compressed image as a first compressed image, and further receives reflected light originating from the second illumination light and coming from the target object to generate a second compressed image in which image information of the wavelength bands is compressed as one piece of image information, and
wherein, based on the first compressed image and the second compressed image, the processor determines whether the reconstructed images are to be generated based on either of the first compressed image and the second compressed image.

### Technique 13

The imaging system according to technique 12,
wherein the processor generates a first edge image based on the first compressed image, the first edge image emphasizing an edge of the first compressed image,
wherein the processor generates a second edge image based on the second compressed image, the second edge image emphasizing an edge of the second compressed image, and
wherein, based on a comparison between an amount of the edge included in the first edge image and an amount of the edge included in the second edge image, the processor determines whether the reconstructed images are to be generated based on either of the first compressed image and the second compressed image.

### Technique 14

The imaging system according to technique 1 or 2,
wherein the illuminator outputs the illumination light as first illumination light and further outputs second illumination light and third illumination light, the second illumination light having a different spectral shape from the first illumination light, the third illumination light having a uniform spectral intensity in the target wavelength range,
wherein the imager generates the compressed image as a first compressed image, further receives reflected light originating from the second illumination light and coming from the target object to generate a second compressed image in which image information of the wavelength bands is compressed as one piece of image information, and receives reflected light originating from the third illumination light and coming from the target object to generate a third compressed image in which image information of the wavelength bands is compressed as one piece of image information, and
wherein the processor generates the reconstructed images based on the first compressed image, the second compressed image, and the third compressed image.

### Technique 15

The imaging system according to technique 14,
wherein the processor generates a first edge image based on the first compressed image, the first edge image emphasizing an edge of the first compressed image,
wherein the processor generates a second edge image based on the second compressed image, the second edge image emphasizing an edge of the second compressed image,
wherein the processor determines a reconstruction parameter for generating the reconstructed images based on the first edge image and the second edge image, and
wherein the processor generates the reconstructed images based on the reconstruction parameter and the third compressed image.

### Technique 16

A method executed by a computer, the method comprising:
causing an illuminator to output illumination light to be radiated onto a target object; and
causing an imager to generate a compressed image, the imager receiving reflected light originating from the illumination light and coming from the target object and generating the compressed image in which image information of wavelength bands included in a target wavelength range is compressed as one piece of image information,
wherein the wavelength bands include a first wavelength band and a second wavelength band, and
wherein a light intensity in the first wavelength band included in the illumination light and a light intensity in the second wavelength band included in the illumination light are different from each other.

### Technique 17

The method according to technique 16, further comprising generating reconstructed images based on the compressed image, each reconstructed image corresponding to a different one of the wavelength bands.

### Technique 18

A method executed by a computer, the method comprising:
acquiring first data related to a spectral reflectance characteristic of a target object;
acquiring second data related to a spectrum of illumination light radiated onto the target object,
acquiring third data related to a spectral sensitivity characteristic of each pixel of an imager that captures an image of the target object; and
generating an estimated image based on the first data, the second data, and the third data, the estimated image being estimated to be generated in a case where the imager captures the image of the target object irradiated with the illumination light.

### Technique 19

The method according to technique 18, further comprising generating and outputting an edge image emphasizing an edge of the estimated image.

### Technique 20

The method according to technique 18, further comprising determining whether or not the spectrum of the illumination light is suitable for generating a spectral image of the target object based on the estimated image.

Each technique according to the present disclosure may be used in, for example, a camera and a measurement device that acquire a multi-wavelength or high-resolution image. Each technique according to the present disclosure is also applicable to, for example, biological, medical, or cosmetic-oriented sensing, a system for inspecting foreign matter and residual pesticides in food, a remote sensing system, and a vehicular sensing system.

What is claimed is:

1. An imaging system comprising:
an illuminator that outputs illumination light to be radiated onto a target object;
an imager that receives reflected light originating from the illumination light and coming from the target object and generates a compressed image in which image information of wavelength bands included in a target wavelength range is compressed as one piece of image information; and
a processor that generates reconstructed images based on the compressed image, each reconstructed image corresponding to a different one of the wavelength bands,
wherein the wavelength bands include a first wavelength band and a second wavelength band, and
wherein a light intensity in the first wavelength band included in the illumination light and a light intensity in the second wavelength band included in the illumination light are different from each other.

2. The imaging system according to claim 1, wherein an intensity of the illumination light increases or decreases monotonously in accordance with an increase in wavelength in the target wavelength range.

3. The imaging system according to claim 1, wherein the processor further generates an edge image based on the compressed image, the edge image emphasizing an edge of the compressed image.

4. The imaging system according to claim 3, wherein the processor causes a display to display the edge image and the compressed image.

5. The imaging system according to claim 3,
wherein the imager includes an optical element and an image sensor, the optical element including regions with different transmission spectra from each other, the image sensor generating the compressed image by receiving light transmitted through the optical element, and
wherein the processor generates the edge image based on mask data and the compressed image, the mask data reflecting a spatial distribution of the transmission spectra of the optical element.

6. The imaging system according to claim 3,
wherein the imager includes an optical element and an image sensor, the optical element including regions with different transmission spectra from each other, the image sensor generating the compressed image by receiving light transmitted through the optical element, and
wherein the processor generates the edge image based on mask data and at least one reconstructed image included in the reconstructed images, the mask data reflecting a spatial distribution of the transmission spectra of the optical element.

7. The imaging system according to claim 3, wherein the processor generates a superimposed image by superimposing the compressed image and the edge image on each other and outputs the superimposed image.

8. The imaging system according to claim 3,
wherein the illuminator outputs the illumination light as first illumination light and further outputs second illumination light having a different spectral shape from the first illumination light,
wherein the imager generates the compressed image as a first compressed image, and further receives reflected light originating from the second illumination light and coming from the target object to generate a second compressed image in which image information of the wavelength bands is compressed as one piece of image information,
wherein the processor generates the edge image as a first edge image, and
wherein the processor further generates a second edge image based on the second compressed image, and generates and outputs a difference image indicating a difference between the first edge image and the second edge image.

9. The imaging system according to claim 1,
wherein the illuminator outputs the illumination light as first illumination light and further outputs second illumination light having a different spectral shape from the first illumination light,
wherein the imager generates the compressed image as a first compressed image, and further receives reflected light originating from the second illumination light and coming from the target object to generate a second compressed image in which image information of the wavelength bands is compressed as one piece of image information, and
wherein the processor determines whether or not switching from a mode for outputting the first illumination light from the illuminator to a mode for outputting the second illumination light from the illuminator is necessary based on the first compressed image.

10. The imaging system according to claim 9,
wherein the processor generates a first edge image based on the first compressed image, the first edge image emphasizing an edge of the first compressed image, and
wherein the processor determines whether or not the switching from the mode for outputting the first illumination light from the illuminator to the mode for outputting the second illumination light from the illuminator is necessary based on an amount of the edge included in the first edge image.

11. The imaging system according to claim 10,
wherein the processor acquires a reference image generated by a method different from imaging using the imager, the reference image emphasizing an edge of the target object, and
wherein the processor determines whether or not the switching from the mode for outputting the first illumination light from the illuminator to the mode for outputting the second illumination light from the illuminator is necessary based on a comparison between the first edge image and the reference image.

12. The imaging system according to claim 1,
wherein the illuminator outputs the illumination light as first illumination light and further outputs second illumination light having a different spectral shape from the first illumination light,
wherein the imager generates the compressed image as a first compressed image, and further receives reflected light originating from the second illumination light and coming from the target object to generate a second compressed image in which image information of the wavelength bands is compressed as one piece of image information, and
wherein, based on the first compressed image and the second compressed image, the processor determines whether the reconstructed images are to be generated based on either of the first compressed image and the second compressed image.

13. The imaging system according to claim 12,
wherein the processor generates a first edge image based on the first compressed image, the first edge image emphasizing an edge of the first compressed image,
wherein the processor generates a second edge image based on the second compressed image, the second edge image emphasizing an edge of the second compressed image, and
wherein, based on a comparison between an amount of the edge included in the first edge image and an amount of the edge included in the second edge image, the processor determines whether the reconstructed images are to be generated based on either of the first compressed image and the second compressed image.

14. The imaging system according to claim 1,
wherein the illuminator outputs the illumination light as first illumination light and further outputs second illumination light and third illumination light, the second illumination light having a different spectral shape from the first illumination light, the third illumination light having a uniform spectral intensity in the target wavelength range,
wherein the imager generates the compressed image as a first compressed image, further receives reflected light originating from the second illumination light and coming from the target object to generate a second compressed image in which image information of the wavelength bands is compressed as one piece of image information, and receives reflected light originating from the third illumination light and coming from the target object to generate a third compressed image in which image information of the wavelength bands is compressed as one piece of image information, and
wherein the processor generates the reconstructed images based on the first compressed image, the second compressed image, and the third compressed image.

15. The imaging system according to claim 14,
wherein the processor generates a first edge image based on the first compressed image, the first edge image emphasizing an edge of the first compressed image,
wherein the processor generates a second edge image based on the second compressed image, the second edge image emphasizing an edge of the second compressed image,
wherein the processor determines a reconstruction parameter for generating the reconstructed images based on the first edge image and the second edge image, and
wherein the processor generates the reconstructed images based on the reconstruction parameter and the third compressed image.

16. A method executed by a computer, the method comprising:
causing an illuminator to output illumination light to be radiated onto a target object; and
causing an imager to generate a compressed image, the imager receiving reflected light originating from the illumination light and coming from the target object and generating the compressed image in which image information of wavelength bands included in a target wavelength range is compressed as one piece of image information,
wherein the wavelength bands include a first wavelength band and a second wavelength band, and
wherein a light intensity in the first wavelength band included in the illumination light and a light intensity in the second wavelength band included in the illumination light are different from each other.

17. The method according to claim 16, further comprising generating reconstructed images based on the compressed image, each reconstructed image corresponding to a different one of the wavelength bands.

18. A method executed by a computer, the method comprising:
acquiring first data related to a spectral reflectance characteristic of a target object;
acquiring second data related to a spectrum of illumination light radiated onto the target object,
acquiring third data related to a spectral sensitivity characteristic of each pixel of an imager that captures an image of the target object; and
generating an estimated image based on the first data, the second data, and the third data, the estimated image being estimated to be generated in a case where the imager captures the image of the target object irradiated with the illumination light.

19. The method according to claim 18, further comprising generating and outputting an edge image emphasizing an edge of the estimated image.

20. The method according to claim 18, further comprising determining whether or not the spectrum of the illumination light is suitable for generating a spectral image of the target object based on the estimated image.
